(19) United States
(12) Patent Application Publication
(10) Pub. No.: US 2014/0367883 A1
(43) Pub. Date: Dec. 18, 2014

(54) PRODUCING METHOD OF THERMALLY CONDUCTIVE SHEET

(71) Applicant: NITTO DENKO CORPORATION, Ibaraki-shi, Osaka (JP)

(72) Inventors: Yoshiharu Hatakeyama, Osaka (JP); Saori Yamamoto, Osaka (JP); Miho Yamaguchi, Osaka (JP); Seiji Izutani, Osaka (JP); Kenichi Fujikawa, Osaka (JP)

(73) Assignee: NITTO DENKO CORPORATION, Ibaraki-shi, Osaka (JP)

(21) Appl. No.: 14/375,865

(22) PCT Filed: Feb. 7, 2013
(86) PCT No.: PCT/JP2013/052953

§ 371 Date: Jul. 31, 2014

(30) Foreign Application Priority Data
Feb. 8, 2012 (JP) 2012-025344
Jan. 25, 2013 (JP) 2013-012654
Jan. 25, 2013 (JP) 2013-012655

(51) Int. Cl. B29C 43/24; B29C 43/46; B29C 43/00

(52) U.S. Cl. CPC B29C 43/24; B29C 43/003; B29C 43/46; B29K 2509/04
USPC 264/175

(57) ABSTRACT

A method for producing a thermally conductive sheet includes the steps of preparing a material component containing boron nitride particles in a plate shape and a polymer matrix, forming a long-length sheet from the material component with a calender, and pressing the long-length sheet.

### TECHNICAL FIELD

The present invention relates to a method for producing a thermally conductive sheet, to be specific, to a method for producing a thermally conductive sheet used for power electronics technology.

### BACKGROUND ART

In recent years, power electronics technology that uses a semiconductor element to convert and control electric power is applied in a hybrid device, a high-brightness LED device, an electromagnetic induction heating device, and the like. In the power electronics technology, a high current is converted to heat or the like and thus, a material that is disposed at the semiconductor element is required to have excellent heat dissipating properties (excellent thermally conductive properties).

As such a material, for example, a thermally conductive sheet containing a boron nitride powder in a plate shape and an acrylic acid ester copolymer resin has been proposed (ref: for example, Patent Document 1).

In Patent Document 1, a composition made from the boron nitride powder and the acrylic acid ester copolymer resin is pressed to be formed into a sheet shape.

### PRIOR ART DOCUMENT

### Patent Document

Patent Document 1: Japanese Unexamined Patent Publication No. 2008-280496

### SUMMARY OF THE INVENTION

### Problems to be Solved by the Invention

There is a disadvantage that, however, the thermally conductive sheet obtained by a method proposed in Patent Document 1 has a high porosity and thus, the thermally conductive properties are not capable of being sufficiently improved.

There is also a disadvantage that the thermally conductive sheet in Patent Document 1 has a high porosity, so that the flexibility is reduced and thus, the thermally conductive sheet is not capable of following the outer shape of the semiconductor element and is easily damaged.

Also, there is a disadvantage that the method in Patent Document 1 is a method of simply pressing a composition, so that a boron nitride powder in a plate shape is easily fractured and the thermally conductive properties in a specific direction are reduced.

Furthermore, there is a disadvantage that the method in Patent Document 1 is a method of simply pressing a composition, so that the production efficiency is not capable of being sufficiently improved.

It is an object of the present invention to provide a method for producing a thermally conductive sheet in which a thermally conductive sheet that is capable of sufficiently reducing a porosity and has excellent thermally conductive properties in a plane direction and excellent flexibility is capable of being produced with excellent production efficiency, while fracture of boron nitride particles in a plate shape is effectively prevented.

### Solution to the Problems

In order to achieve the above-described object, a method for producing a thermally conductive sheet of the present invention includes the steps of preparing a material component containing boron nitride particles in a plate shape and a polymer matrix, forming a long-length sheet from the material component with a calender, and pressing the long-length sheet.

In the method for producing a thermally conductive sheet of the present invention, it is preferable that the calender is provided with a plurality of rolls that are disposed so that a plurality of nip portions are formed therein and a gap of a downstream-side nip portion is smaller than that of an upstream-side nip portion in the upstream-side nip portion and the downstream-side nip portion that are adjacent to each other in a conveying direction of the long-length sheet.

In the method for producing a thermally conductive sheet of the present invention, it is preferable that in the two nip portions of the upstream-side nip portion and the downstream-side nip portion, a gap of the downstream-side nip portion with respect to a gap of the upstream-side nip portion is 0.9 times or less.

In the method for producing a thermally conductive sheet of the present invention, it is preferable that at least three nip portions are provided in the calender.

In the method for producing a thermally conductive sheet of the present invention, it is preferable that the thermally conductive sheet has a porosity of 3.0 vol % or less.

In the method for producing a thermally conductive sheet of the present invention, it is preferable that the calender is provided with a plurality of pairs of rolls that are disposed in opposed relation to each other along the conveying direction.

In the method for producing a thermally conductive sheet of the present invention, it is preferable that the thermally conductive sheet has a complex shear viscosity η* of 300 Pa·s or more and 10000 Pa·s or less at a temperature of 20 to 150° C. obtained by a dynamic viscoelasticity measurement in conformity with JIS K7244-10 (in 2005) at a frequency of 10 Hz and a temperature rising rate of 2° C./min.

In the method for producing a thermally conductive sheet of the present invention, it is preferable that the boron nitride particles measured by a dynamic light scattering method have an average particle size of 20 μm or more and the volume ratio of the boron nitride particles in the thermally conductive sheet is 60 vol % or more.

In the method for producing a thermally conductive sheet of the present invention, it is preferable that the thermal conductivity in a direction perpendicular to a thickness direction of the thermally conductive sheet is 6 W/m·K or more.

A thermally conductive sheet of the present invention includes the steps of preparing a material component containing boron nitride particles in a plate shape and a polymer matrix, forming a long-length sheet by extending the material component by applying pressure with a calender provided with at least one pair of rolls, and pressing the long-length sheet, wherein the step of forming the long-length sheet includes the steps of forming the long-length sheet by extending the material component by applying pressure with the one pair of rolls and laminating a plurality of the long-length sheets in the thickness direction to be extended by applying pressure with the one pair of rolls.

In the method for producing a thermally conductive sheet of the present invention, it is preferable that the calender is provided with a plurality of rolled members that are made of one pair of rolls disposed in opposed relation to each other; a plurality of the rolled members correspond to any one of a first rolled member disposed at the upstream side in the conveying direction of the long-length sheet and a second rolled member disposed at the downstream side in the conveying direction of the first rolled member; one piece of the second rolled member is provided corresponding to a plurality of the first rolled members; and in the step of forming the long-length sheet, the long-length sheet is formed by a plurality of the first rolled members and a plurality of the long-length sheets that are formed by a plurality of the first rolled members are collectively extended by applying pressure with the second rolled member.

In the method for producing a thermally conductive sheet of the present invention, it is preferable that two or more steps of laminating a plurality of the long-length sheets are performed.

### Effect of the Invention

In the method for producing a thermally conductive sheet of the present invention, the long-length sheet is formed from the material component with the calender, so that the thermally conductive sheet is capable of being obtained with excellent production efficiency.

Additionally, the long-length sheet is formed with the calender, so that fracture of the boron nitride particles in a plate shape is capable of being effectively prevented.

Furthermore, the long-length sheet is formed from the material component with the calender and the long-length sheet is pressed, so that the porosity of the thermally conductive sheet is capable of being reduced, while the boron nitride particles in a plate shape are oriented along the plane direction perpendicular to the thickness direction in the polymer matrix.

Thus, the thermally conductive sheet having excellent thermally conductive properties and excellent flexibility in the plane direction is capable of being produced with excellent production efficiency.

### BRIEF DESCRIPTION OF THE DRAWINGS

FIG. 1 shows a schematic configuration view of a calender used in a long-length sheet forming step (an embodiment in which five pieces of rolled members are provided in a vertical arrangement) of a method for producing a thermally conductive sheet in a first embodiment of the present invention.

FIG. 2 shows a schematic perspective view of a pressing step of a method for producing a thermally conductive sheet of a first embodiment of the present invention.

FIG. 3 shows a perspective view of a thermally conductive sheet obtained by a method for producing a thermally conductive sheet of a first embodiment of the present invention.

FIG. 4 shows a perspective view of a Type I test device of a bend test (before the bend test).

FIG. 5 shows a perspective view of a Type I test device of a bend test (during the bend test).

FIG. 6 shows a schematic configuration view (an embodiment in which five pieces of rolled members are provided in a horizontal arrangement) of a calender used in another embodiment of a long-length sheet forming step of a method for producing a thermally conductive sheet of the present invention.

FIG. 7 shows a schematic configuration view (an embodiment in which three pieces of rolls are vertically arranged) of a calender used in another embodiment of a long-length sheet forming step of a method for producing a thermally conductive sheet of the present invention.

FIG. 8 shows a schematic configuration view (an embodiment in which four pieces of rolls are vertically arranged) of a calender used in another embodiment of a long-length sheet forming step of a method for producing a thermally conductive sheet of the present invention.

FIG. 9 shows a schematic configuration view (an embodiment in which five pieces of rolls are vertically arranged) of a calender used in another embodiment of a long-length sheet forming step of a method for producing a thermally conductive sheet of the present invention.

FIG. 10 shows a schematic configuration view (an embodiment in which three pieces of rolls are inclinedly arranged) of a calender used in another embodiment of a long-length sheet forming step of a method for producing a thermally conductive sheet of the present invention.

FIG. 11 shows a schematic configuration view (an embodiment in which of three pieces of rolls, the upper-side two pieces are inclinedly arranged) of a calender used in another embodiment of a long-length sheet forming step of a method for producing a thermally conductive sheet of the present invention.

FIG. 12 shows a schematic configuration view (an embodiment in which four pieces of rolls are arranged in an inverted “L” shape) of a calender used in another embodiment of a long-length sheet forming step of a method for producing a thermally conductive sheet of the present invention.

FIG. 13 shows a schematic configuration view (an embodiment in which four pieces of rolls are arranged in an “L” shape) of a calender used in another embodiment of a long-length sheet forming step of a method for producing a thermally conductive sheet of the present invention.

FIG. 14 shows a schematic configuration view (an embodiment in which four pieces of rolls are arranged in a “Z” shape) of a calender used in another embodiment of a long-length sheet forming step of a method for producing a thermally conductive sheet of the present invention.

FIG. 15 shows a schematic configuration view (an embodiment in which four pieces of rolls are arranged in an “S” shape) of a calender used in another embodiment of a long-length sheet forming step of a method for producing a thermally conductive sheet of the present invention.

FIG. 16 shows a schematic configuration view (an embodiment in which five pieces of rolls are arranged in an inverted “L” shape) of a calender used in another embodiment of a long-length sheet forming step of a method for producing a thermally conductive sheet of the present invention.

FIG. 17 shows a schematic configuration view (an embodiment in which five pieces of rolls are arranged in a “7” shape) of a calender used in another embodiment of a long-length sheet forming step of a method for producing a thermally conductive sheet of the present invention.

FIG. 18 shows a schematic configuration view (an embodiment in which five pieces of rolls are arranged in an “M” shape) of a calender used in another embodiment of a long-length sheet forming step of a method for producing a thermally conductive sheet of the present invention.

FIG. 19 shows a schematic configuration view (an embodiment in which one pair of rolls is disposed in opposed relation to each other in a right-left direction) of a calender used in another embodiment of a long-length sheet forming step of a method for producing a thermally conductive sheet of the present invention.

FIG. 20 shows a schematic configuration view (an embodiment in which one pair of rolls is disposed in opposed relation to each other in an up-down direction) of a calender used in another embodiment of a long-length sheet forming step of a method for producing a thermally conductive sheet of the present invention.

FIG. 21 shows a processed SEM image of a thermally conductive sheet in Example 1.

FIG. 22 shows a processed SEM image of a thermally conductive sheet in Example 4.

FIG. 23 shows a processed SEM image of boron nitride particles.

FIG. 24 shows a schematic configuration view of a calender used in a long-length sheet forming step of a method for producing a thermally conductive sheet in a second embodiment of the present invention.

FIG. 25 shows a modified example of the calender in FIG. B1 and shows an embodiment in which a sheet laminated portion has a single step.

FIG. 26 shows a processed SEM image of a thermally conductive sheet in Example B10.

FIG. 27 shows a processed SEM image of boron nitride particles.

FIG. 28 shows a schematic configuration view of a calender in Comparative Examples B8, B13, and B15.

### EMBODIMENT OF THE INVENTION

The present invention is described by illustrating a first embodiment and a second embodiment. Hereinafter, the details are described by each of the embodiments.

### First Embodiment

A method for producing a thermally conductive sheet in the first embodiment includes the steps of preparing a material component (a material preparing step), forming a long-length sheet from the material component with a calender (a long-length sheet forming step), and pressing the long-length sheet (a pressing step).

Hereinafter, each of the steps is described in detail.

<Material Preparing Step>

The material component contains boron nitride particles and a polymer matrix.

The boron nitride particles are formed into a plate shape (or a flake shape). The plate shape is required to include at least a flat plate shape having an aspect ratio and includes a circular plate shape and a hexagonal flat plate shape in a thickness direction of the plate. The plate shape may be a laminate in a plurality of layers. When the plate shape is a laminate, a shape obtained by laminating plate shapes each having a different size in step shapes and a shape having an end surface cleaved are included. The plate shape includes a linear shape (ref: FIG. 3) in a direction perpendicular to the thickness direction of the plate (a plane direction) and furthermore, a shape in which a linear shape thereof is slightly bent at a midway position.

The boron nitride particles have an average length in a longitudinal direction (the maximum length in the direction perpendicular to the thickness direction of the plate) of particles that account for 60% or more by volume ratio of, for example, 5 μm or more, preferably 10 μm or more, more preferably 20 μm or more, particularly preferably 30 μm or more, or most preferably 40 μm or more, and of, for example, 300 μm or less.

The boron nitride particles have an average thickness (the length in the thickness direction of the plate, that is, the length in a short-side direction of the particles) of particles that account for 60% or more by volume ratio of, for example, 0.01 μm or more, or preferably 0.1 μm or more, and of, for example, 20 μm or less, or preferably 15 μm or less.

The boron nitride particles have an aspect ratio (the length in the longitudinal direction/the thickness) of particles that account for 60% or more by volume ratio of, for example, 2 or more, preferably 3 or more, or more preferably 4 or more, and of, for example, 10,000 or less, preferably 5,000 or less, or more preferably 2,000 or less.

The form, thickness, length in the longitudinal direction, and aspect ratio of the boron nitride particles are measured and calculated by an image analysis method. The form, thickness, length in the longitudinal direction, and aspect ratio of the boron nitride particles are capable of being obtained by, for example, SEM, X-ray CT, or a particle size distribution image analysis method.

The boron nitride particles have an average particle size measured by a light scattering method of, for example, 5 μm or more, preferably 10 μm or more, more preferably 20 μm or more, particularly preferably 30 μm or more, or most preferably 40 μm or more, and of, for example, 200 μm or less.

The average particle size measured by the light scattering method is a volume average particle size measured by a dynamic light scattering method that uses a dynamic light scattering type particle size distribution analyzer.

When the average particle size of the boron nitride particles measured by the light scattering method is below the above-described range, there may be a case where even in the case of mixing the boron nitride particles having the same volume, the thermal conductivity is reduced.

The boron nitride particles have a bulk density (JIS K 5101, an apparent density) of, for example, 0.1 g/cm³ or more, preferably 0.15 g/cm³ or more, more preferably 0.2 g/cm³ or more, or particularly preferably 0.2 g/cm³, and of, for example, 2.3 g/cm³ or less, preferably 2.0 g/cm³ or less, more preferably 1.8 g/cm³ or less, or further more preferably 1.5 g/cm³ or less.

As the boron nitride particles, a commercially available product or processed goods thereof can be used. Examples of the commercially available product of the boron nitride particles include the “PT” series (for example, “PT-110”) manufactured by Momentive Performance Materials Inc. and the “SHOBN™ UHP” series (for example, “SHOBN™ UHP-1”) manufactured by Showa Denko K.K.

The material component may contain other inorganic microparticles in addition to the above-described boron nitride particles. Examples of the other inorganic microparticles include carbide such as silicon carbide; a nitride such as silicon nitride (excluding boron nitride); an oxide such as silicon oxide (silica) and aluminum oxide (alumina); a metal such as copper and silver; and carbonaceous particles such as carbon black. The other inorganic microparticles may be functional particles having, for example, flame retardancy, cold storage performance, antistatic performance, magnetic properties, reflective index adjusting properties, or dielectric constant adjusting properties.

The material component may contain minute boron nitride or boron nitride particles in a deformed shape that fail to be included in the above-described boron nitride particles.

These other inorganic microparticles can be used alone or in combination of two or more at an appropriate proportion.

Examples of the polymer matrix include a thermosetting resin component, a thermoplastic resin component, and a polymer component such as a rubber component.

Examples of the thermosetting resin component include an epoxy resin, a thermosetting polyimide, a phenol resin, a urea resin, a melamine resin, an unsaturated polyester resin, a diallyl phthalate resin, a silicone resin, and a thermosetting urethane resin.

Of the thermosetting resin components, preferably, an epoxy resin is used.

The epoxy resin is in a state of liquid, semi-solid, or solid at a normal temperature.

To be specific, examples of the epoxy resin include an aromatic epoxy resin such as a bisphenol epoxy resin (for example, a bisphenol A epoxy resin, a bisphenol F epoxy resin (including a crystalline bisphenol epoxy resin), a bisphenol S epoxy resin, a hydrogenated bisphenol A epoxy resin, and a dimer acid-modified bisphenol epoxy resin), a novolak epoxy resin (for example, a phenol novolak epoxy resin, a cresol novolak epoxy resin, and a biphenyl epoxy resin), a naphthalene epoxy resin, a fluorene epoxy resin (for example, a bisaryl fluorene epoxy resin), and a triphenylmethane epoxy resin (for example, a trishydroxyphenylmethane epoxy resin); a nitrogen-containing-cyclic epoxy resin such as a triepoxypropyl isocyanurate (a triglycidyl isocyanurate) and a hydantoin epoxy resin; an aliphatic epoxy resin; an alicyclic epoxy resin (for example, a dicyclo ring-type epoxy resin such as a dicyclopentadiene epoxy resin); a glycidylether epoxy resin; and a glycidylamine epoxy resin.

These epoxy resins can be used alone or in combination of two or more. Preferably, an epoxy resin in a semi-solid state is used alone or an epoxy resin in a solid state and an epoxy resin in a liquid state are used in combination.

Preferably, an aromatic epoxy resin and an alicyclic epoxy resin are used.

The epoxy resin has an epoxy equivalent of, for example, 100 g/eqiv. or more, or preferably 180 g/eqiv. or more, and of, for example, 1000 g/eqiv. or less, or preferably 700 g/eqiv. or less.

The epoxy resin can be also prepared as an epoxy resin composition by containing, for example, a curing agent and a curing accelerator.

The curing agent is a latent curing agent (an epoxy resin curing agent) that is capable of curing the epoxy resin by heating. Examples thereof include an imidazole compound, an amine compound, an acid anhydride compound, an amide compound, a hydrazide compound, an imidazoline compound, and a phenol compound. In addition to the above-described compounds, examples thereof also include a urea compound and a polysulfide compound.

Examples of the imidazole compound include a 2-phenyl imidazole, a 2-methyl imidazole, a 2-ethyl-4-methyl imidazole, and a 2-phenyl-4-methyl-5-hydroxymethyl imidazole.

Examples of the amine compound include a polyamine such as an ethylene diamine, a propylene diamine, a diethylene triamine, and a triethylene tetramine and amine adducts thereof; a metha phenylenediamine; a diaminodiphenyl methane; and a diaminodiphenyl sulfone.

Examples of the acid anhydride compound include a phthalic anhydride, a maleic anhydride, a tetrahydrophthalic anhydride, a hexahydrophthalic anhydride, a 4-methyl-hexahydrophthalic anhydride, a methyl nadic anhydride, a pyromellitic anhydride, a dodecenylsuccinic anhydride, a dichloro succinic anhydride, a benzophenone tetracarboxylic anhydride, and a chlorendic anhydride.

Examples of the amide compound include a dicyandiamide and a polyamide.

An example of the hydrazide compound includes an adipic acid dihydrazide.

Examples of the imidazoline compound include a methyl imidazoline, a 2-ethyl-4-methyl imidazoline, an ethyl imidazoline, an isopropyl imidazoline, a 2,4-dimethyl imidazoline, a phenyl imidazoline, an undecyl imidazoline, a heptadecyl imidazoline, and a 2-phenyl-4-methyl imidazoline.

Examples of the phenol compound include a novolak phenol resin obtained by condensing phenol and formaldehyde under an acid catalyst and a phenol-aralkyl resin obtained by synthesizing phenol and dimethoxyparaxylene or bis(methoxymethyl)biphenyl.

These curing agents can be used alone or in combination of two or more.

As the curing agent, preferably, an imidazole compound and a phenol compound are used.

Examples of the curing accelerator include a tertiary amine compound such as a triethylenediamine and a tri-2,4,6-dimethylaminomethylphenol; a phosphorus compound such as a triphenylphosphine, a tetraphenylphosphoniumtetraphenylborate, and a tetra-n-butylphosphonium-o,o-diethylphosphorodithioate; a triazine compound such as 2,4-diamino-6-[2′-methylimidazolyl-(1′)]-ethyl-s-triazine isocyanuric acid adduct; a quaternary ammonium salt compound; an organic metal salt compound; and derivatives thereof. These curing accelerators can be used alone or in combination of two or more. Preferably, a trizaine compound is used.

In the epoxy resin composition, the mixing ratio of the curing agent with respect to 100 parts by mass of the epoxy resin is, for example, 0.5 parts by mass or more, or preferably 1 part by mass or more, and is, for example, 1000 parts by mass or less, or preferably 500 parts by mass or less and the mixing ratio of the curing accelerator with respect to 100 parts by mass of the epoxy resin is, for example, 0.1 parts by mass or less, or preferably 0.2 parts by mass or less, and is, for example, 10 parts by mass or less, or preferably 5 parts by mass or less.

The above-described curing agent and/or curing accelerator can be used by being prepared as a solvent solution and/or a solvent dispersion liquid obtained by being dissolved and/or dispersed with a solvent as required.

An example of the solvent includes an organic solvent such as ketone including acetone and methyl ethyl ketone, ester including ethyl acetate, and amide including N,N-dimethylformamide. An example of the solvent also includes an aqueous solvent such as water and an alcohol including methanol, ethanol, propanol, and isopropanol. As the solvent, preferably, an organic solvent is used, or more preferably, ketone is used.

Examples of the thermoplastic resin component include a polyolefin (for example, a polyethylene, a polypropylene, and an ethylene-propylene copolymer), an acrylic resin (for example, a polymethyl methacrylate), a polyvinyl acetate, an ethylene-vinyl acetate copolymer, polyvinyl chloride, polystyrene, a polyacrylonitrile, a polyamide (nylon (registered trademark)), a polycarbonate, a polyacetal, a polyethylene terephthalate, a polyphenylene oxide, a polyphenylene sulfide, a polysulfone, a polyether sulfone, a poly ether ether ketone, a polyallyl sulfone, a thermoplastic polyimide, a thermoplastic urethane resin, a polyamino-bismaleimide, a polyamide imide, a polyether imide, a bismaleimide triazine resin, a polymethylpentene, a fluorine resin, a liquid crystal polymer, an olefin-vinyl alcohol copolymer, an ionomer, a polyarylate, an acrylonitrile-ethylene-styrene copolymer, an acrylonitrile-butadiene-styrene copolymer, and an acrylonitrile-styrene copolymer.

The rubber component is a polymer that develops rubber elasticity and contains, for example, an elastomer. To be specific, examples thereof include a urethane rubber, an acrylic rubber, a silicone rubber, a vinyl alkyl ether rubber, a polyvinyl alcohol rubber, a polyvinyl pyrrolidone rubber, a polyacrylamide rubber, a cellulose rubber, a natural rubber, a butadiene rubber, a chloroprene rubber, a styrene-butadiene rubber (SBR), an acrylonitrile-butadiene rubber (NBR), a styrene-ethylene-butadiene-styrene rubber, a styrene-isoprene-styrene rubber, a styrene-isobutylene rubber, an isoprene rubber, a polyisobutylene rubber, and a butyl rubber.

As the rubber component, preferably an acrylic rubber is used.

The acrylic rubber is a synthetic rubber obtained by polymerization of a monomer that contains an alkyl (meth)acrylate.

The alkyl (meth)acrylate is an alkyl methacrylate and/or an alkyl acrylate. An example thereof includes a straight chain or branched chain alkyl (meth)acrylate containing an alkyl portion having 1 to 10 carbon atoms such as a methyl (meth)acrylate, an ethyl (meth)acrylate, a butyl (meth)acrylate, a hexyl (meth)acrylate, a 2-ethyl hexyl (meth)acrylate, and a nonyl (meth)acrylate. Preferably, a straight chain alkyl (meth)acrylate containing an alkyl portion having 2 to 8 carbon atoms is used.

The mixing ratio of the alkyl (meth)acrylate with respect to the monomer is, for example, 50 mass % or more, or preferably 75 mass % or more, and is, for example, 99 mass % or less.

The monomer can contain a copolymerizable monomer that is capable of polymerizing with an alkyl (meth)acrylate.

The copolymerizable monomer contains a vinyl group. Examples thereof include a cyano group-containing vinyl monomer such as (meth)acrylonitrile and an aromatic vinyl monomer such as styrene.

The mixing ratio of the copolymerizable monomer with respect to the monomer is, for example, 50 mass % or less, or preferably 25 mass % or less, and is, for example, 1 mass % or more.

These copolymerizable monomers can be used alone or in combination of two or more.

In order to increase the adhesive force, the acrylic rubber may contain a functional group that is bonded to an end or a middle of the main chain. Examples of the functional group include a carboxyl group, a hydroxyl group, an epoxy group, and an amide group. Preferably, an epoxy group is used.

The acrylic rubber has a weight average molecular weight of, for example, 10,000 or more, preferably 50,000 or more, or more preferably 100,000 or more, and of, for example, 10,000,000 or less, preferably 5,000,000 or less, more preferably 3,000,000 or less, or most preferably 1,000,000 or less. The weight average molecular weight (calibrated with standard polystyrene) of the acrylic rubber is calculated with GPC.

The acrylic rubber has a glass transition temperature of, for example, −100° C. or more, preferably −80° C. or more, more preferably −50° C. or more, or further more preferably −40° C. or more, and of, for example, 200° C. or less, preferably 100° C. or less, more preferably 100° C. or less, further more preferably 50° C. or less, or most preferably 40° C. or less.

The glass transition temperature of the acrylic rubber is calculated by, for example, a midpoint glass transition temperature or a theoretical calculated value after heat treatment measured based on JIS K 7121-1987. When the glass transition temperature of the acrylic rubber is measured based on JIS K7121-1987, to be specific, the glass transition temperature is calculated at a temperature rising rate of 10° C./min in a differential scanning calorimetry (heat flux DSC).

These rubber components can be used alone or in combination of two or more.

The rubber component can be used as a rubber component solution prepared by being dissolved with the above-described solvent as required.

When the rubber component is prepared as a rubber component solution, the content ratio of the rubber component with respect to the rubber component solution is, for example, 1 mass % or more, preferably 2 mass % or more, or more preferably 5 mass % or more, and is, for example, 99 mass % or less, preferably 90 mass % or less, or more preferably 80 mass % or less.

These polymer components can be used alone or in combination of two or more.

Of the polymer components, preferably, a thermosetting resin component and a rubber component are used.

The mixing ratio of the thermosetting resin component with respect to the polymer matrix is, for example, 0.1 mass % or more, preferably 1 mass % or more, or more preferably 5 mass % or more, and is, for example, 100 mass % or less, preferably 99.9 mass % or less, or more preferably 99 mass % or less.

The mixing ratio of the rubber component with respect to the polymer matrix is, for example, 0.1 mass % or more, preferably 1 mass % or more, or more preferably 5 mass % or more, and is, for example, 100 mass % or less, preferably 99.9 mass % or less, or more preferably 99 mass % or less.

The mixing ratio of the boron nitride particles with respect to 100 parts by mass of the total amount (the total amount of the solid content) of the material component, based on mass, is, for example, 40 parts by mass or more, or preferably 65 parts by mass or more, and is, for example, 95 parts by mass or less, or preferably 90 parts by mass or less. The mixing ratio of the polymer matrix with respect to 100 parts by mass of the total amount of the material component, based on mass, is, for example, 5 parts by mass or more, or preferably 10 parts by mass or more, and is, for example, 60 parts by mass or less, or preferably 35 parts by mass or less. The mixing ratio of the boron nitride particles with respect to 100 parts by mass of the polymer matrix, based on mass, is, for example, 60 parts by mass or more, or preferably 185 parts by mass or more, and is, for example, 1900 parts by mass or less, or preferably 900 parts by mass or less.

The polymer matrix contains, for example, a polymer precursor (for example, a low molecular weight polymer containing an oligomer) and/or a monomer in addition to the above-described components (polymers).

In order to prepare the material component, the above-described components (components containing the boron nitride particles and the polymer matrix) and the solvent are blended and stirred to be then dried, so that the material component is obtained as a material powder.

An example of the solvent includes the same solvent as that blended in the above-described curing agent and/or curing accelerator. The mixing ratio of the solvent with respect to 100 parts by mass of the total amount of the boron nitride particles and the polymer matrix is, for example, 20 parts by mass or more, or preferably 50 parts by mass or more, and is, for example, 2000 parts by mass or less, or preferably 500 parts by mass or less.

An example of a drying method includes a vacuum drying method in which the material component is subjected to vacuum heating at, for example, 0° C. or more, or preferably 10° C. or more, and at, for example, 80° C. or less, or preferably 40° C. or less at, for example, 0.01 Pa or more, or preferably 0.1 Pa or more, and at, for example, 300 Pa or less, or preferably 100 Pa or less.

Or, a material powder can be also prepared from the material component by a known tumbling fluidized bed granulation method or the like.

<Long-Length Sheet Forming Step>

Next, in this method, a thermally conductive sheet is formed from the above-described material component with a calender.

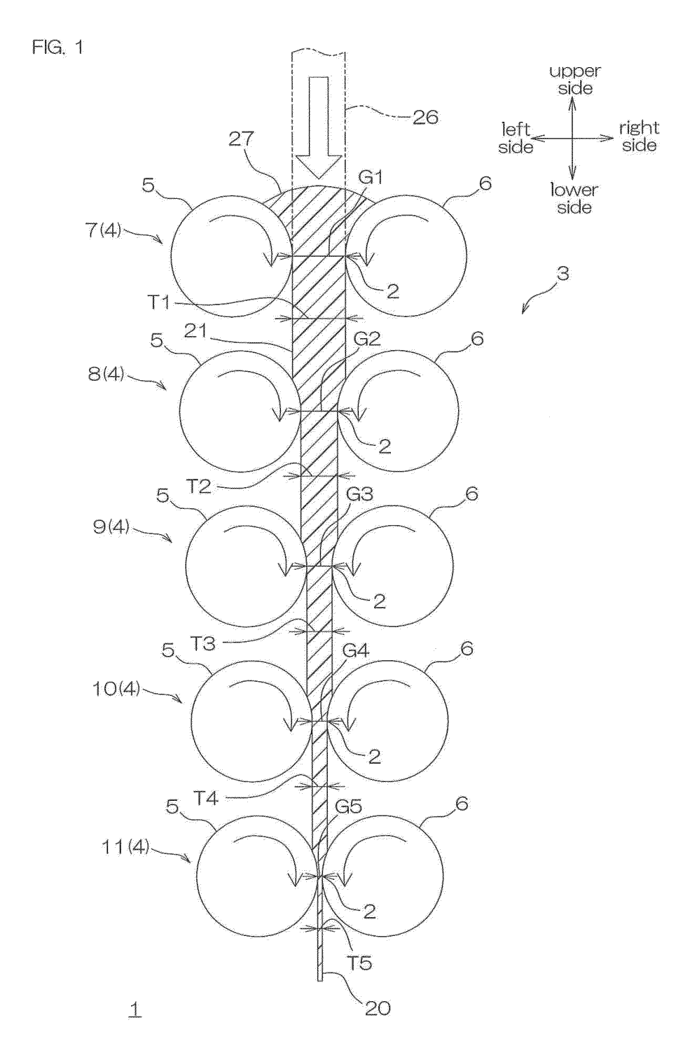

Next, a calender used in the long-length sheet forming step is described with reference to FIG. 1.

In FIG. 1, a calender 1 is a calendering forming device provided with a plurality of rolls 3 that are disposed so that a plurality of nip portions 2 are formed therein.

To be specific, the calender 1 is provided with rolled members 4 that are made of one pair of a roll 5 and a roll 6 disposed in opposed relation to each other in a direction (a right-left direction in FIG. 1) perpendicular to a conveying direction (an up-down direction in FIG. 1, a vertical direction) of a long-length sheet 20 (to be specific, the long-length sheet 20 before a thermally conductive sheet 100 is formed by pressing).

A plurality of the rolled members 4 are disposed in alignment at spaced intervals to each other along the conveying direction. That is, in a plurality of the rolled members 4, a plurality of pairs of the roll 5 and the roll 6 are disposed along the conveying direction.

Each of a plurality of the rolled members 4 includes the first roll 5 and the second roll 6 that is opposed thereto and the nip portion 2 (that is, a gap between the first roll 5 and the second roll 6) of the first roll 5 and the second roll 6 is formed.

The first roll 5 and the second roll 6 are made of, for example, a metal such as stainless steel, iron, or copper. The first roll 5 and the second roll 6 are preferably made of stainless steel.

The first roll 5 and the second roll 6 are provided so as to revolve in the same direction (downwardly) at the nip portion 2 thereof so that the long-length sheet 20 is capable of being conveyed at the downstream side in the conveying direction (downwardly).

The revolving rate of the first roll 5 and the second roll 6 is set within a range of, for example, 50 m/min or less, or preferably 10 m/min or less, and of, for example, 0.01 m/min or more.

The first roll 5 and the second roll 6 are heated by a heat source that is not shown as required. When the polymer matrix contains a thermosetting resin component, for example, the surface temperature thereof is set at a temperature at which the thermosetting resin component is brought into a B-stage state. To be specific, the surface temperature of the first roll 5 and the second roll 6 is set within a range of, for example, 20° C. or more, or preferably 40° C. or more, and of, for example, 150° C. or less, or preferably 80° C. or less.

The first roll 5 and the second roll 6 are formed to have a diameter of, for example, 80 mm or more, or preferably 100 mm or more, and of, for example, 1000 mm or less, or preferably 700 mm or less and to have a length in an axial direction of, for example, 100 mm or more, or preferably 200 mm or more, and of, for example, 3000 mm or less, or preferably 2000 mm or less.

To be specific, a plurality of the rolled members 4 are assigned to a first rolled member 7, a second rolled member 8 disposed at spaced intervals to the downstream side in the conveying direction of the first rolled member 7, a third rolled member 9 disposed at spaced intervals to the downstream side in the conveying direction of the second rolled member 8, a fourth rolled member 10 disposed at spaced intervals to the downstream side in the conveying direction of the third rolled member 9, and a fifth rolled member 11 disposed at spaced intervals to the downstream side in the conveying direction of the fourth rolled member 10.

The first rolled member 7, the second rolled member 8, the third rolled member 9, the fourth rolled member 10, and the fifth rolled member 11 are disposed in a linear shape (an “I” shape) extending in the conveying direction (the up-down direction).

Gaps G of the nip portions 2 between the first rolls 5 and the second rolls 6 in a plurality of the rolled members 4 are set so as to be sequentially smaller toward the downstream side in the conveying direction.

To be specific, a gap G1 of the nip portion 2 of the first rolled member 7, a gap G2 of the nip portion 2 of the second rolled member 8, a gap G3 of the nip portion 2 of the third rolled member 9, a gap G4 of the nip portion 2 of the fourth rolled member 10, and a gap G5 of the nip portion 2 of the fifth rolled member 11 satisfy, for example, the following formula (1).

G1>G2>G3>G4>G5 (1)

In the upstream-side rolled member 4 and the downstream-side rolled member 4 that are adjacent to each other in the conveying direction, a gap (Gap, hereinafter the same) G′ of the nip portion 2 of the downstream-side rolled member 4 with respect to the gap G of the nip portion 2 of the upstream-side rolled member 4 is, for example, 0.99 times or less, preferably 0.95 times or less, or more preferably 0.9 times or less, and is, for example, 0.1 times or more.

In other words, a ratio R (G′/G) of the gap G′ of the nip portion 2 of the downstream-side rolled member 4 to the gap G of the nip portion 2 of the upstream-side rolled member 4 is, for example, 0.99 or less, preferably 0.95 or less, or more preferably 0.9 or less, and is, for example, 0.1 or more.

To be more specific, a ratio R_{2/1} of the gap G2 of the nip portion 2 of the second rolled member 8 to the gap G1 of the nip portion 2 of the first rolled member 7, a ratio R_{3/2} of the gap G3 of the nip portion 2 of the third rolled member 9 to the gap G2 of the nip portion 2 of the second rolled member 8, a ratio R_{4/3} of the gap G4 of the nip portion 2 of the fourth rolled member 10 to the gap G3 of the nip portion 2 of the third rolled member 9, and a ratio R_{5/4} of the gap G5 of the nip portion 2 of the fifth rolled member 11 to the gap G4 of the nip portion 2 of the third rolled member 11 satisfy, for example, the following formula (2).

R_{2/1}≦R_{3/2}≦R_{4/3}≦R_{5/4} (2)

(wherein, in the formula, R_{2/1} is G2/G1, R_{3/2} is G3/G2, R_{4/3} is G4/G3, and R_{5/4} is G5/G4.)

Preferably, the following formula (3) is satisfied.

R_{2/1}>R_{3/2}>R_{4/3}>R_{5/4} (3)

(wherein, in the formula, R_{2/1}, R_{3/2}, R_{4/3}, and R_{5/4} are the same as those described above.)

To be specific, the gap G1 of the nip portion 2 of the first rolled member 7 is, for example, 0.2 mm or more, or preferably 0.3 mm or more, and is, for example, 5 mm or less, or preferably 3 mm or less. The gap G2 of the nip portion 2 of the second rolled member 8 is, for example, 0.1 mm or more, and is, for example, 4 mm or less, or preferably 3 mm or less. The gap G3 of the nip portion 2 of the third rolled member 9 is, for example, 0.1 mm or more, and is, for example, 3 mm or less, or preferably 2 mm or less. The gap G4 of the nip portion 2 of the fourth rolled member 10 is, for example, 0.1 mm or more, and is, for example, 2 mm or less, or preferably 1 mm or less. The gap G5 of the nip portion 2 of the fifth rolled member 11 is, for example, 0.1 mm or more, and is, for example, 1 mm or less, or preferably 0.8 mm or less.

R_{2/1}, R_{3/2}, R_{4/3}, and R_{5/4} are, for example, 0.1 or more, or preferably 0.2 or more, and are, for example, 0.9 or less, or preferably 0.8 or less.

In the calender 1, a winding roll (not shown) is provided at spaced intervals to the downstream side in the conveying direction of the fifth rolled member 11 as required.

In the long-length sheet forming step, in order to form the long-length sheet 20 from the material component with the calender 1, first, a material component 27 is charged from the upper side of the nip portion 2 of the first rolled member 7.

The charged amount of the material component 27 is, for example, 0.01 kg/min or more, or preferably 0.02 kg/min or more, and is, for example, 50 kg/min or less, or preferably 5 kg/min or less.

Next, the material component 27 that is charged into the nip portion 2 of the first rolled member 7 is, at the nip portion 2 of the first rolled member 7, by the revolutions of the first roll 5 and the second roll 6, conveyed to the downstream side in the conveying direction (downwardly), while being extended by applying pressure, to be formed into the long-length sheet 20, and then, the long-length sheet 20 is sent from the first rolled member 7 toward the second rolled member 8.

A thickness T1 of the long-length sheet 20 formed by the first rolled member 7 is, for example, 0.2 mm or more, or preferably 0.25 mm or more, and is, for example, 5 mm or less, or preferably 4 mm or less.

Next, the long-length sheet 20 sent from the first rolled member 7 then reaches and enters the nip portion 2 of the second rolled member 8 by the revolutions of the first roll 5 and the second roll 6 of the second rolled member 8. Thereafter, by the revolutions of the first roll 5 and the second roll 6 of the second rolled member 8, the long-length sheet 20 is conveyed to the downstream side in the conveying direction (downwardly), while being extended by applying pressure, to be sent from the nip portion 2 of the second rolled member 8.

A thickness T2 of the long-length sheet 20 formed by the second rolled member 8 is thinner than the thickness T1 of the long-length sheet 20 formed by rolling of the first rolled member 7. The thickness T2 with respect to the thickness T1 is, for example, 99% or less, preferably 95% or less, or more preferably 90% or less, and is, for example, 10% or more.

To be specific, the thickness T2 of the long-length sheet 20 formed by the second rolled member 8 is, for example, 0.1 mm or more, or preferably 0.2 mm or more, and is, for example, 4 mm or less, or preferably 3 mm or less.

Next, the long-length sheet 20 sent from the second rolled member 8 then reaches and enters the nip portion 2 of the third rolled member 9 by the revolutions of the third rolled member 9. Thereafter, by the revolutions of the first roll 5 and the second roll 6 of the third rolled member 9, the long-length sheet 20 is conveyed to the downstream side in the conveying direction (downwardly), while being extended by applying pressure, to be sent from the nip portion 2 of the third rolled member 9.

A thickness T3 of the long-length sheet 20 formed by the third rolled member 9 is thinner than the thickness T2 of the long-length sheet 20 formed by rolling of the second rolled member 8. The thickness T3 with respect to the thickness T2 is, for example, 99% or less, preferably 95% or less, or more preferably 90% or less, and is, for example, 10% or more.

To be specific, the thickness T3 of the long-length sheet 20 formed by the third rolled member 9 is, for example, 0.1 mm or more, and is, for example, 3 mm or less, or preferably 2 mm or less.

Next, the long-length sheet 20 sent from the third rolled member 9 then reaches and enters the nip portion 2 of the fourth rolled member 10 by the revolutions of the fourth rolled member 10. Thereafter, by the revolutions of the first roll 5 and the second roll 6 of the fourth rolled member 10, the long-length sheet 20 is conveyed to the downstream side in the conveying direction (downwardly), while being extended by applying pressure, to be sent from the nip portion 2 of the fourth rolled member 10.

A thickness T4 of the long-length sheet 20 formed by the fourth rolled member 10 is thinner than the thickness T3 of the long-length sheet 20 formed by rolling of the third rolled member 9. The thickness T4 with respect to the thickness T3 is, for example, 99% or less, preferably 95% or less, or more preferably 90% or less, and is, for example, 10% or more.

To be specific, the thickness T4 of the long-length sheet 20 formed by the fourth rolled member 10 is, for example, 0.1 mm or more, and is, for example, 2 mm or less, or preferably 1 mm or less.

Next, the long-length sheet 20 sent from the fourth rolled member 10 then reaches and enters the nip portion 2 of the fifth rolled member 11 by the revolutions of the fifth rolled member 11. Thereafter, by the revolutions of the first roll 5 and the second roll 6 of the fifth rolled member 11, the long-length sheet 20 is conveyed to the downstream side in the conveying direction (downwardly), while being extended by applying pressure, to be sent from the nip portion 2 of the fifth rolled member 11.

A thickness T5 of the long-length sheet 20 formed by the fifth rolled member 11 is thinner than the thickness T4 of the long-length sheet 20 formed by rolling of the fourth rolled member 10. The thickness T5 with respect to the thickness T4 is, for example, 99% or less, preferably 95% or less, or more preferably 90% or less, and is, for example, 10% or more.

To be specific, the thickness T5 of the long-length sheet 20 formed by the fifth rolled member 11 is, for example, 0.05 mm or more, or preferably 0.1 mm or more, and is, for example, 1 mm or less, or preferably 0.8 mm or less.

Thereafter, the long-length sheet 20 sent from the fifth rolled member 11 is wound up by a winding roll that is not shown.

In this way, the long-length sheet 20 is capable of being obtained.

Although not shown in FIG. 1, for example, a release sheet is also capable of being provided on the surfaces (the left surface and the right surface) of the long-length sheet 20 to be extended by applying pressure with the calender 1. To be specific, the material component 27 is sandwiched between two release sheets (not shown) and the formed laminate is extended by applying pressure with the calender 1.

Examples of the release sheet include a resin sheet such as a polyester (to be specific, polyethylene terephthalate (PET) and the like) sheet, a polyolefin sheet, and a silicone rubber sheet and a metal foil such as stainless steel and iron. Preferably, a resin sheet is used. The surface of the release sheet can be also subjected to a known release treatment.

The release sheet has a thickness of, for example, 10 μm or more, or preferably 30 μm or more, and of, for example, 300 μm or less, or preferably 250 μm or less.

A commercially available product can be used as the release sheet. To be specific, examples of the PET sheet include the DIAFOIL MRF series, the DIAFOIL MRX series, and the DIAFOIL MRN series (all described above are manufactured by Mitsubishi Plastics, Inc.) and the PANA-PEEL series and the SG series (all described above are manufactured by PANAC Corporation).

<Pressing Step>

The pressing step is performed after the long-length sheet forming step.

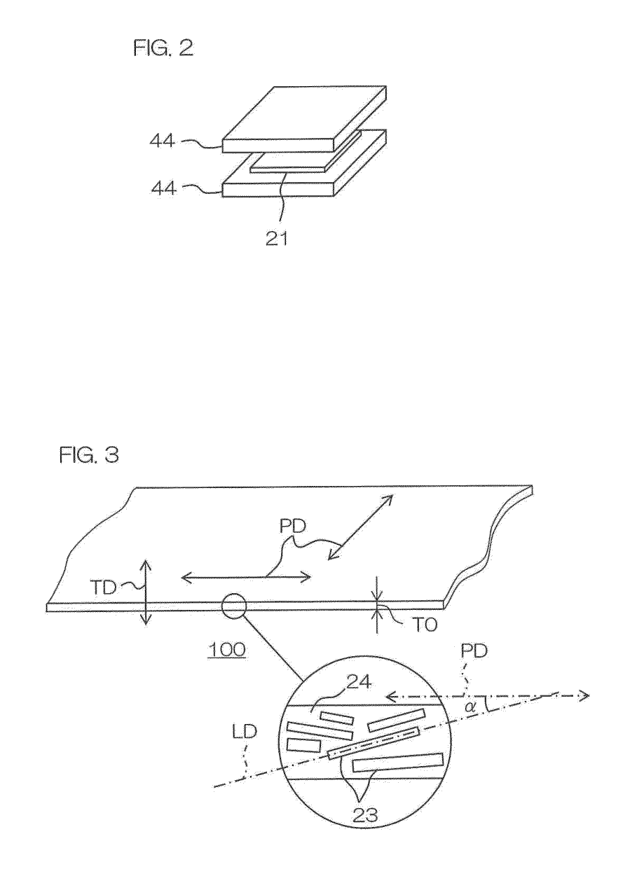

To be specific, the long-length sheet 20 formed in the long-length sheet forming step is cut into a predetermined size and a sheet 21 is formed. Thereafter, as shown in FIG. 2, the sheet 21 is pressed by, for example, a pressing device such as a vacuum pressing device, so that a thermally conductive sheet is obtained.

To be specific, for example, the long-length sheet 20 is cut into a rectangular shape to form the sheet 21. A release sheet that is not shown is peeled from the sheet 21 as required. Thereafter, while other release sheets 44 (the release sheets different from the release sheets used in the long-length sheet forming step) are interposed, the long-length sheet 20 is sandwiched therebetween to be then pressed under a vacuum as required. As the release sheet 44, the release sheet (not shown) used in the long-length sheet forming step is also capable of being used as it is.

Or, the release sheet 44 is capable of being used by laminating a plurality of the release sheets 44.

Furthermore, in the pressing, a spacer in a frame shape is capable of being provided on the periphery of the sheet 21. The spacer is made of, for example, a metal and has a thickness of, for example, 0.05 to 1 mm.

A vacuum pressure of the vacuum pressing device is, for example, 100 Pa or less, preferably 50 Pa or less, more preferably 20 Pa or less, or further more preferably 10 Pa or less, and is, for example, 0.01 Pa or more.

In the vacuum pressing, the sheet 21 is set in the vacuum pressing device; a vacuum is created at the inside of the vacuum pressing device; and thereafter, the pressing can be started. In such a case, a duration after a vacuum is created at the inside of the vacuum pressing device until the start of the pressing is, for example, 0.1 minutes or more, preferably, 0.5 minutes or more, more preferably 1 minute or more, or further more preferably 2 minutes or more, and is, for example, 1 hour or less, preferably 30 minutes or less, more preferably 10 minutes or less, or further more preferably 5 minutes or less.

A pressing pressure, as an effective pressure, is, for example, 0.5 MPa or more, preferably 1 MPa or more, more preferably 3 MPa or more, further more preferably 5 MPa or more, or particularly preferably 10 MPa or more, and is, for example, 100 MPa or less.

A pressing duration is, for example, 1 minute or more, preferably 3 minutes or more, more preferably 5 minutes or more, or further more preferably 10 minutes or more, and is, for example, 5 hours or less, preferably 2 hours or less, more preferably 1 hour or less, or further more preferably 30 minutes or less.

Also, performance of pressing and heating, that is, hot pressing is capable of being achieved.

The temperature at the hot pressing is, for example, 20° C. or more, preferably 30° C. or more, or more preferably 40° C. or more, and is, for example, 150° C. or less, preferably 120° C. or less, or more preferably 80° C. or less.

The thermally conductive sheet 100 obtained in the pressing step is in a B-stage state when the polymer matrix contains a thermosetting resin component.

A thickness T0 (ref: FIG. 3) of the thermally conductive sheet 100 that is obtained is, for example, 0.05 mm or more, or preferably 0.1 mm or more, and is, for example, 1 mm or less, preferably 0.8 mm or less, more preferably 0.6 mm or less, or further more preferably 0.4 mm or less.

The content ratio of boron nitride particles 23 in the thermally conductive sheet 100, based on volume, is, for example, 35 vol % or more, preferably 50 vol % or more, more preferably 60 vol % or more, or further more preferably 65 vol % or more, and is, for example, 95 vol % or less, or preferably 90 vol % or less.

When the content proportion of the boron nitride particles 23 is below the above-described range, the boron nitride particles 23 may not be capable of being oriented in a plane direction PD (described later) in the thermally conductive sheet 100. When the content proportion of the boron nitride particles 23 is above the above-described range, the flexibility of the thermally conductive sheet 100 may be reduced.

In the thermally conductive sheet 100 obtained in this way, as refereed in FIG. 3, a longitudinal direction LD of the boron nitride particles 23 is oriented along the plane direction PD that crosses (is perpendicular to) a thickness direction TD of the thermally conductive sheet 100.

The calculated average of the angle between the longitudinal direction LD of the boron nitride particles 23 and the plane direction PD of the thermally conductive sheet 100 (an orientation angle α of the boron nitride particles 23 with respect to the thermally conductive sheet 100) is, for example, 25 degrees or less, or preferably 20 degrees or less, and is, for example, 0 degree or more.

In this way, the thermal conductivity in the plane direction PD of the thermally conductive sheet 100 is, for example, 6 W/m·K or more, preferably 10 W/m·K or more, more preferably 15 W/m·K or more, or particularly preferably 20 W/m·K or more, and is, for example, 200 W/m·K or less.

The thermal conductivity in the plane direction PD of the thermally conductive sheet 100 is substantially the same before and after thermally curing (complete curing) to be described later.

When the thermal conductivity in the plane direction PD of the thermally conductive sheet 100 is below the above-described range, the thermally conductive properties in the plane direction PD are not sufficient, so that the thermally conductive sheet 100 may not be capable of being used for heat dissipation application that requires the thermally conductive properties in the plane direction PD.

The thermal conductivity in the plane direction PD of the thermally conductive sheet 100 is measured by a pulse heating method. In the pulse heating method, the xenonflash analyzer “LFA-447” (manufactured by Erich NETZSCH GmbH & Co. Holding KG) is used.

The thermal conductivity in the thickness direction TD of the thermally conductive sheet 100 is, for example, 0.5 W/m·K or more, or preferably 1 W/m·K or more, and is, for example, 15 W/m·K or less, or preferably 10 W/m·K or less.

The thermal conductivity in the thickness direction TD of the thermally conductive sheet 100 is measured by a pulse heating method, a laser flash method, or a TWA method. In the pulse heating method, the above-described device is used, in the laser flash method, “TC-9000” (manufactured by Ulvac, Inc.) is used, and in the TWA method, “ai-Phase mobile” (manufactured by ai-Phase Co., Ltd) is used.

In this way, the ratio (the thermal conductivity in the plane direction PD/the thermal conductivity in the thickness direction TD) of the thermal conductivity in the plane direction PD of the thermally conductive sheet 100 to that in the thickness direction TD of the thermally conductive sheet 100 is, for example, 1.5 or more, preferably 3 or more, or more preferably 4 or more, and is, for example, 50 or less.

The density of the thermally conductive sheet 100 is, for example, 1.5 g/cm² or more, preferably 1.55 g/cm² or more, more preferably 1.6 g/cm² or more, particularly preferably 1.65 g/cm² or more, or most preferably 1.7 g/cm² or more, and is, for example, 4 g/cm² or less.

As referred in FIG. 21, for example, pores (gaps) 28 may be formed in the thermally conductive sheet 100.

The ratio of the pores 28 in the thermally conductive sheet 100, that is, a porosity P, is, for example, 3.0 vol % or less, preferably 2.5 vol % or less, more preferably 2.0 vol % or less, or further more preferably 1.5 vol % or less, and is, for example, 0 vol % or more.

The above-described porosity P is measured by, for example, as follows: a theoretical density of the boron nitride particles is assumed to be 2.28 g/cm³ and a theoretical density of the polymer matrix is assumed to be 1.2 g/cm³, so that a theoretical density (ρA, 1.956 g/cm³) thereof is calculated; furthermore, a density ρB calculated from the thickness, the area of a piece, and the weight at the time of die-cutting the thermally conductive sheet 100 with a punch having a diameter of 25 mm is calculated; and next, the porosity P=100×(ρB/ρA) is calculated from the density that is measured and calculated in the description above.

The porosity P is measured by, for example, as follows: the thermally conductive sheet 100 is cut along the thickness direction with a cross section polisher (CP); the cross section thus appeared is observed with a scanning electron microscope (SEM) at a magnification of 200 to obtain an image; the obtained image is binarized based on the pore 28 portion and the non-pore portion; and the area ratio, that is, the ratio of the pore 28 portion area to the total area of the cross section of the thermally conductive sheet 100 is determined by calculation.

In the measurement of the porosity P, the thermally conductive sheet 100 in a B-stage (a semi-cured) state is used.

When the porosity P of the thermally conductive sheet 100 is within the above-described range, the thermally conductive properties and the conformability to irregularities (properties of the thermally conductive sheet 100 that conforms to be in tight contact with the irregularities when the thermally conductive sheet 100 is provided at an object with irregularities to be installed) of the thermally conductive sheet 100 can be improved.

The complex shear viscosity η* of the thermally conductive sheet 100 at least any temperature in a temperature range of 20 to 150° C. (preferably, in particular, at 70° C.) obtained by a dynamic viscoelasticity measurement is, for example, 300 Pa·s or more, preferably 500 Pa·s or more, or more preferably 800 Pa·s or more, and is, for example, 5×10⁴ Pa·s or less, preferably 3×10⁴ Pa·s or less, or more preferably 1×10⁴ Pa·s or less.

The dynamic viscoelasticity measurement is in conformity with JIS K7244-10 (in 2005) and is measured in a shear mode at a frequency of 10 Hz and a temperature rising rate of 2° C./min.

When the complex shear viscosity η* of the thermally conductive sheet 100 is within the above-described range, the processability (the formability) of the material component can be improved.

When the thermally conductive sheet 100 is evaluated in a bend test in conformity with a cylindrical mandrel method of JIS K 5600-5-1 under the following test conditions, for example, fracture is not observed.

Test Conditions:

Test device: Type I

Mandrel: diameter of 1 mm, 5 mm, and 10 mm

Bending angle: 90 to 180 degrees

Thickness of thermally conductive sheet 100: 0.1 to 2 mm (to be specific, 0.2 mm)

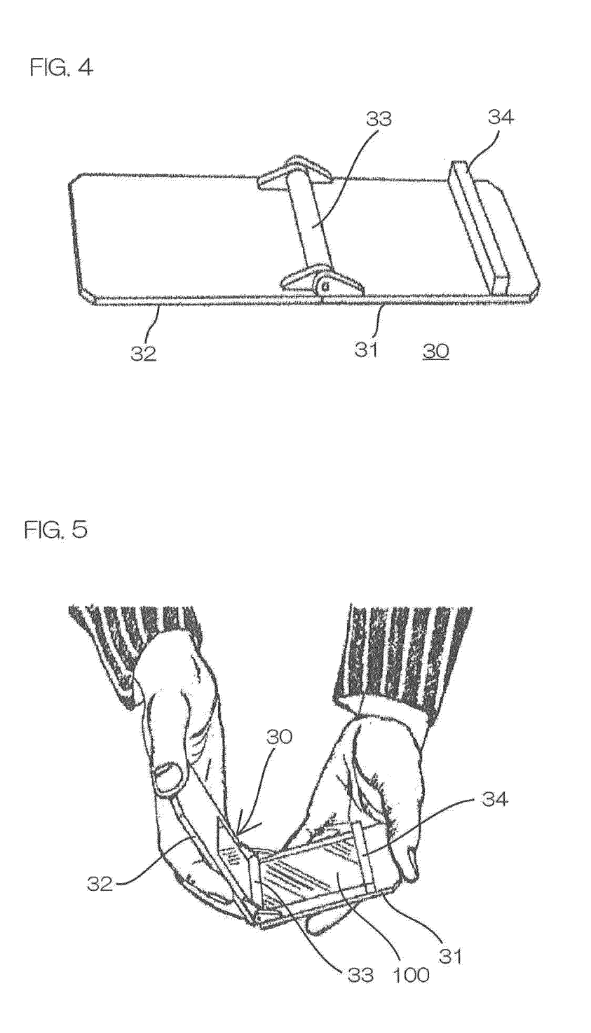

The perspective views of the Type I test device are shown in FIGS. 4 and 5. In the following, the Type I test device is described.

In FIGS. 4 and 5, a Type I test device 30 includes a first flat plate 31, a second flat plate 32 that is disposed in parallel with the first flat plate 31, and a mandrel (a revolving axis) 33 that is provided for allowing the first flat plate 31 and the second flat plate 32 to revolve relatively.

The first flat plate 31 is formed into a generally rectangular flat plate shape. A stopper 34 is provided at one end portion (a free end portion) of the first flat plate 31. The stopper 34 is formed on the surface of the first flat plate 31 so as to extend along the one end portion of the first flat plate 31.

The second flat plate 32 is formed into a generally rectangular flat plate shape and one side thereof is disposed so as to be adjacent to one side (one side of the other end portion (the proximal end portion) that is the opposite side to the one end portion in which the stopper 34 is provided) of the first flat plate 31.

The mandrel 33 is formed so as to extend along one side of the first flat plate 31 and the second flat plate 32 that are adjacent to each other.

As shown in FIG. 4, in the type I test device 30, the surface of the first flat plate 31 is flush with the surface of the second flat plate 32 before the start of the bend test.

In order to perform the bend test, the thermally conductive sheet 100 is placed on the surface of the first flat plate 31 and the surface of the second flat plate 32. The thermally conductive sheet 100 is placed so that one side thereof is in contact with the stopper 34.

Next, as shown in FIG. 5, the first flat plate 31 and the second flat plate 32 are revolved relatively. To be specific, the free end portion of the first flat plate 31 and the free end portion of the second flat plate 32 are revolved to a predetermined angle with the mandrel 33 as the center. To be more specific, the first flat plate 31 and the second flat plate 32 are revolved so as to bring the surfaces of the free end portions thereof closer (opposed to each other).

In this way, the thermally conductive sheet 100 is bent with the mandrel 33 as the center, while conforming to the revolving of the first flat plate 31 and the second flat plate 32.

Preferably, fracture is not observed in the thermally conductive sheet 100, even when the bending angle is set to be 180 degrees under the above-described test conditions.

When fracture is observed in the thermally conductive sheet 100 in the bend test at the above-described bending angle, excellent flexibility may not be capable of being imparted to the thermally conductive sheet 100.

When the polymer matrix contains a thermosetting resin component, the thermally conductive sheet 100 in a B-stage state is used in the bend test.

The thermally conductive sheet 100 is attached to a heat dissipation object that serves as an adherend. Thereafter, when the polymer matrix contains a thermosetting resin component, the resulting thermally conductive sheet 100 is bonded to the heat dissipation object by being thermally cured by heating (being brought into a C-stage state).

In order to thermally cure the thermally conductive sheet 100, the thermally conductive sheet 100 is heated at, for example, 60° C. or more, or preferably 80° C. or more, and at, for example, 250° C. or less, or preferably 200° C. or less for, for example, 5 minutes or more, or preferably 10 minutes or more, and for, for example, 300 minutes or less, or preferably 200 minutes or less.

In the method for producing the thermally conductive sheet of the present invention, the thermally conductive sheet 100 is formed from the material component 27 with the calender 1, so that the thermally conductive sheet 100 is capable of being obtained with excellent production efficiency.

Additionally, fracture of the boron nitride particles 23 in a plate shape is capable of being effectively prevented.

The material component 27 is allowed to pass through the upstream-side nip portion 2 and the downstream-side nip portion 2 that are adjacent to each other in the up-down direction, that is, the rolled member 4. In the calender 1, the gap G′ of the nip portion 2 at the downstream side is set to be smaller than the gap G of the nip portion 2 at the upstream side.

That is, in the calender 1, the gap G2 of the nip portion 2 of the second rolled member 8 is set to be smaller than the gap G1 of the nip portion 2 of the first rolled member 7, the gap G3 of the nip portion 2 of the third rolled member 9 is set to be smaller than the gap G2 of the nip portion 2 of the second rolled member 8, the gap G4 of the nip portion 2 of the fourth rolled member 10 is set to be smaller than the gap G3 of the nip portion 2 of the third rolled member 9, and the gap G5 of the nip portion 2 of the fifth rolled member 8 is set to be smaller than the gap G4 of the nip portion 2 of the first rolled member 7.

In other words, the gaps G1 to G5 of the nip portions 2 of the rolled members 4 are set to be sequentially smaller toward the downstream side in the conveying direction.

Thus, the porosity P is capable of being reduced, while the boron nitride particles 23 in a plate shape are efficiently oriented along the plane direction PD in a polymer matrix 24.

Thus, the thermally conductive sheet 100 having excellent thermally conductive properties and excellent flexibility in the plane direction PD is capable of being produced with excellent production efficiency.

As a result, the thermally conductive sheet 100 having excellent flexibility and excellent thermally conductive properties in the plane direction PD is capable of being used for various heat dissipation applications.

To be specific, when an electronic element is covered with the thermally conductive sheet 100, heat of the electronic element is capable of being efficiently thermally conducted, while the electronic element is capable of being protected.

The electronic element that is covered with the thermally conductive sheet 100 is not particularly limited and examples thereof include an IC (integrated circuit) chip, a condenser, a coil, a resistor, and a light emitting diode. These electronic elements are usually provided on a substrate and are disposed at spaced intervals to each other in the plane direction (the plane direction of the substrate).

Among all, when an electronic component used for power electronics and/or a mounted substrate on which the electronic component is mounted are/is covered with the thermally conductive sheet 100, heat of the electronic component and/or the mounted substrate is capable of being dissipated along the plane direction PD by the thermally conductive sheet 100, while deterioration of the thermally conductive sheet 100 by heat is capable of being prevented.

Examples of the electronic component used for power electronics include an IC (integrated circuit) chip (among all, a narrow-width electrode terminal portion in the IC chip), a thyristor (a rectifier), a motor component, an inverter, a power transmission component, a condenser, a coil, a resistor, and a light emitting diode.

The above-described electronic components are mounted on the surface (one surface) of the mounted substrate and the electronic components are disposed at spaced intervals to each other in the plane direction (the plane direction of the mounted substrate) in the mounted substrate.

The thermally conductive sheet 100 having excellent heat resistance is also capable of being provided in, for example, an LED heat dissipation substrate and a heat dissipating material for a battery.

In the embodiment shown by solid lines in FIG. 1, the material component containing the solvent is dried and the material powder is prepared to be then charged into the calender 1. Alternatively, for example, as shown by phantom lines in FIG. 1, after the material component containing the solvent is formed into a material sheet 26 with an extruder or the like, the material sheet 26 can be also charged into the calender 1.

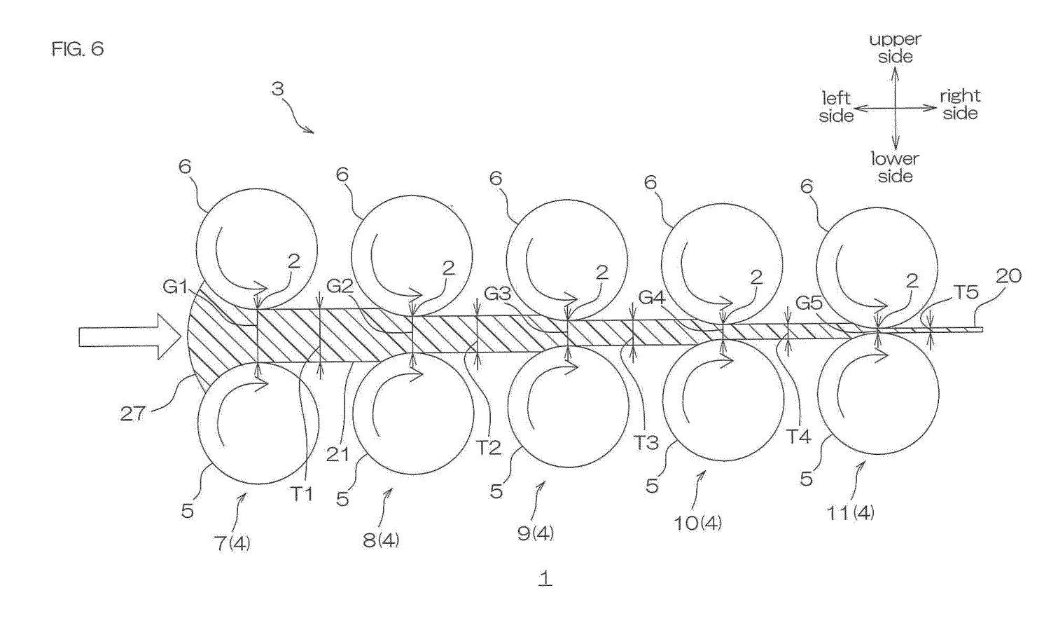

Next, another embodiment of the calender in the long-length sheet forming step of the present invention is described with reference to FIGS. 6 to 18.

In each figure to be described below, the same reference numerals are provided for members corresponding to each of those described above, and their detailed description is omitted.

In the embodiment in FIG. 1, the calender 1 has a vertical arrangement in which a plurality of the rolled members 4 are vertically arranged in series so as to extend in the up-down direction. Alternatively, for example, as shown in FIG. 6, the calender 1 can also have a horizontal arrangement in which a plurality of the rolled members 4 are horizontally arranged in series so as to extend in the right-left direction.

The method for producing the thermally conductive sheet using the calender 1 in FIG. 6 has the same function and effect as that of the method for producing the thermally conductive sheet using the calender 1 in FIG. 1.

In the embodiment in FIG. 1, in the rolled members 4, each of the first rolls 5 and the second rolls 6 is arranged in an “I” shape along the conveying direction. However, the arrangement thereof is not particularly limited to this.

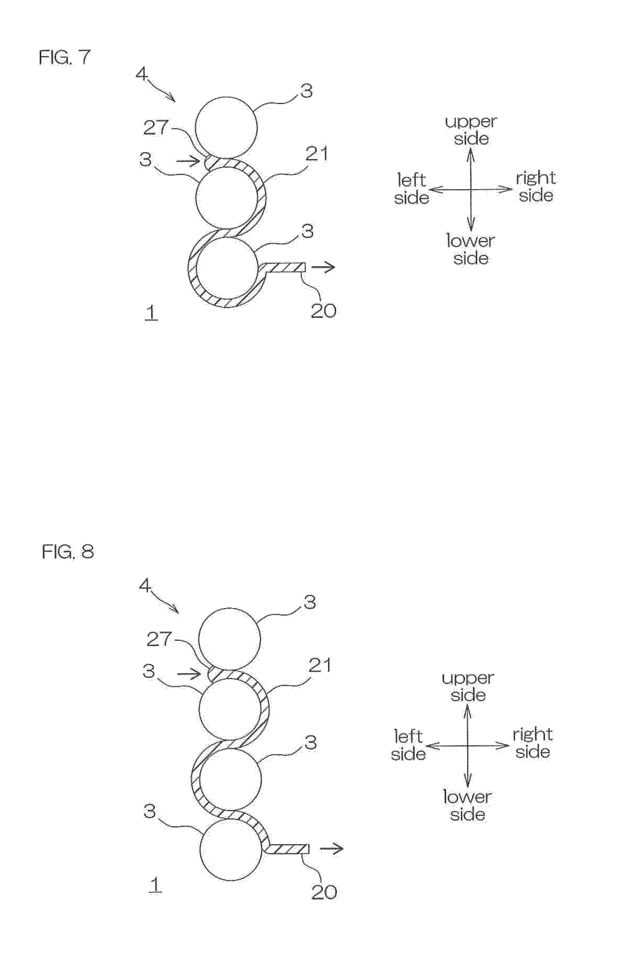

As shown in FIGS. 7 to 18, for example, the calender 1 can also consist of the rolled members 4 that are made of the rolls 3 formed in various arrangements.

In each of the calenders 1 shown in FIGS. 7 to 18, a path of the long-length sheet 20 is formed in a bent shape, so that the long-length sheet 20 is bent, while being extended by applying pressure, and in this way, the thermally conductive sheet 100 is produced.

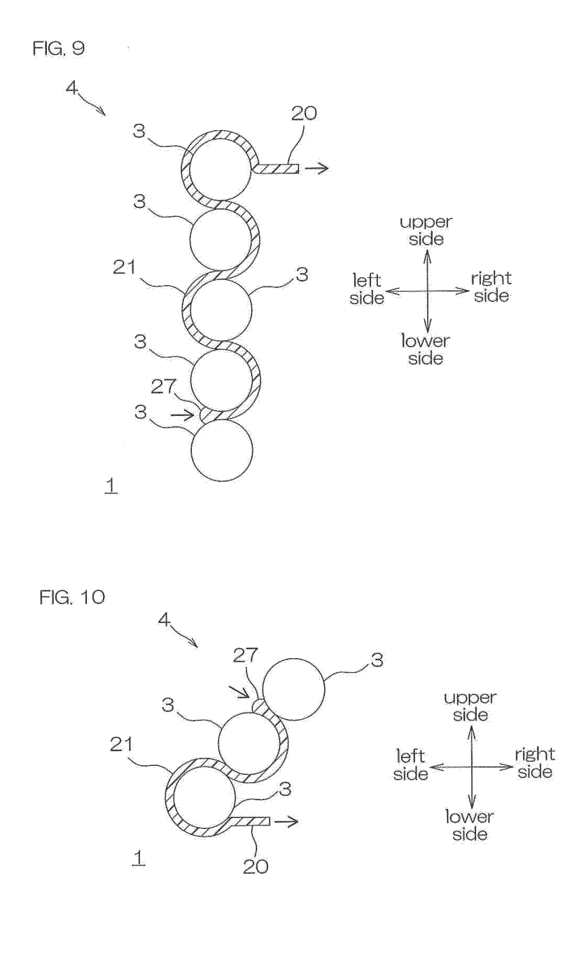

To be specific, in each of the calenders 1 in FIGS. 7 to 9, a plurality (in FIG. 7, three pieces, in FIG. 8, and in FIG. 9, four pieces) of the rolls 3 are arranged in alignment in tight contact with each other so as to be upright in the up-down direction.

In the calender 1 in FIG. 10, a plurality (three pieces) of the rolls 3 are inclinedly arranged in alignment with respect to the up-down direction.

In the calender 1 in FIG. 11, of a plurality (three pieces) of the rolls 3, the upper-side two pieces of the rolls 3 are disposed in opposed relation to each other in an inclined direction with respect to the up-down direction.

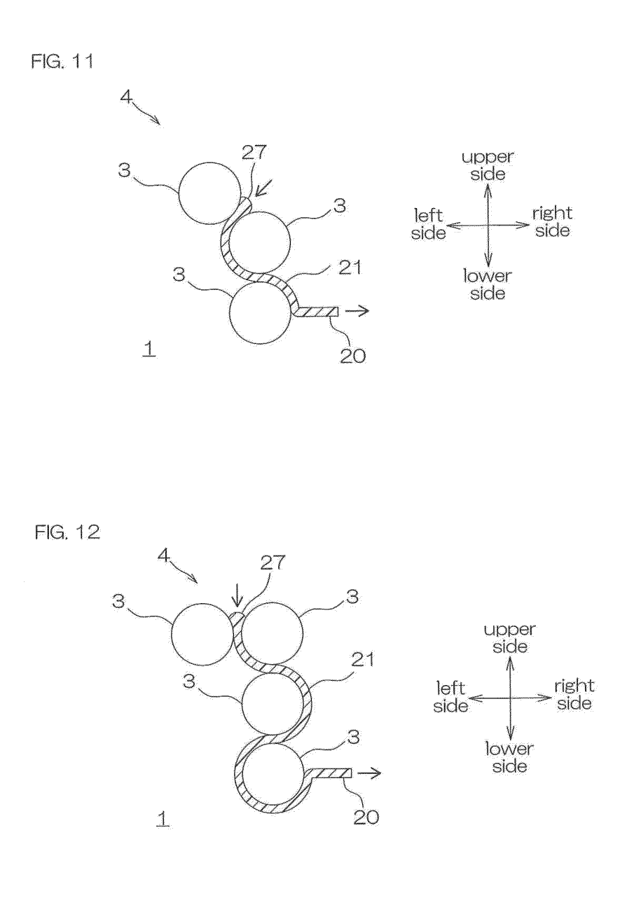

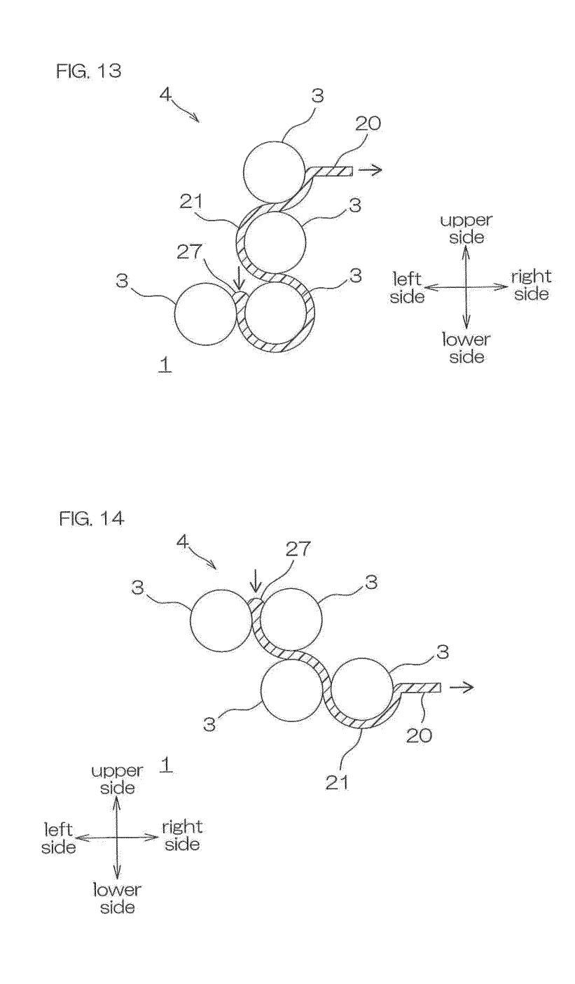

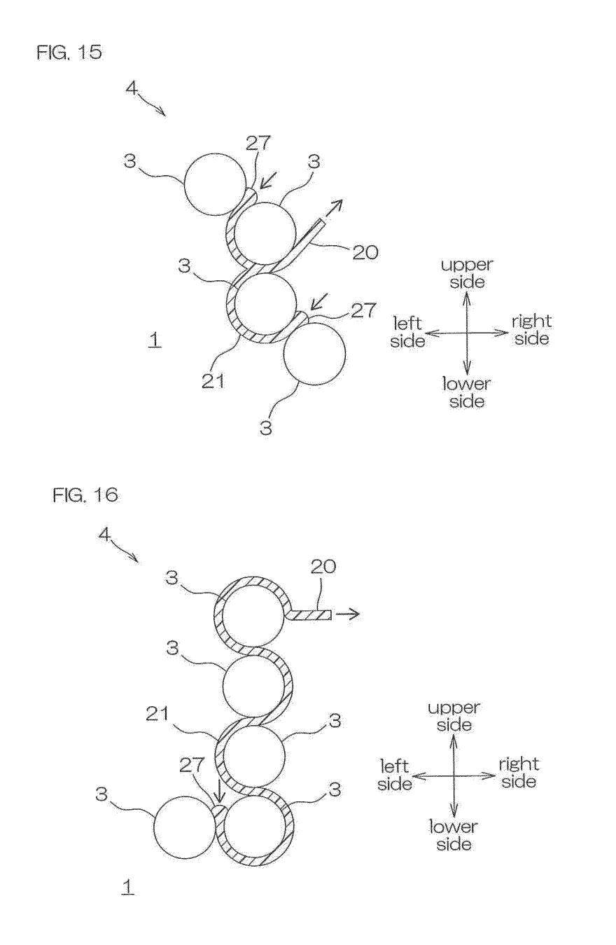

In FIGS. 8 and 12 to 15, the rolled members 4 are made of four pieces of the rolls 3. The rolls 3 are arranged in an inverted “L” shape in FIG. 12, in an “L” shape in FIG. 13, in a “Z” shape in FIG. 14, and in an “S” shape in FIG. 15.

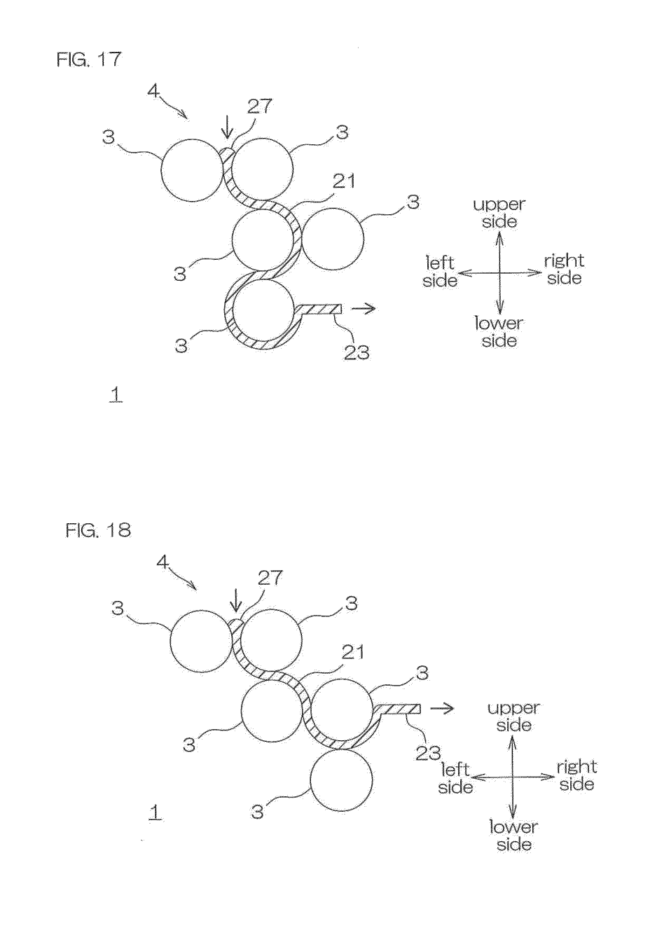

In FIGS. 9 and 16 to 18, the rolled members 4 are made of five pieces of the rolls 3. The rolls 3 are arranged in an inverted “L” shape in FIG. 16, in a “7” shape in FIG. 17, and in an “M” shape in FIG. 18.

The method for producing the thermally conductive sheet 100 using the calender 1 in FIGS. 7 to 18 has the same function and effect as that of the method for producing the thermally conductive sheet 100 using the calender 1 shown in FIG. 1.

Preferably, the method for producing the thermally conductive sheet 100 using the calender 1 shown in FIGS. 1 and 6 is used. According to this method, the rolled members 4 are arranged in a linear shape and a path of the long-length sheet 20 is formed so as to extend in a linear shape, so that occurrence of stress that bends the boron nitride particles 23 in a plate shape is capable of being prevented and in this way, fracture of the boron nitride particles 23 is capable of being further effectively prevented.

In the embodiment in FIG. 1, five pieces of the rolled members 4 are provided. The number of pieces of the rolled member 4 is not particularly limited, however, as long as a plurality of the rolled members 4 are formed so that a plurality of the nip portions 2 are formed. Examples thereof include, for example, two to ten pieces (excluding five pieces), or preferably three to seven pieces (excluding five pieces).

Preferably, three or more pieces of the rolled members 4 are provided. In this way, the long-length sheet 20 is capable of being sufficiently efficiently extended by applying pressure.

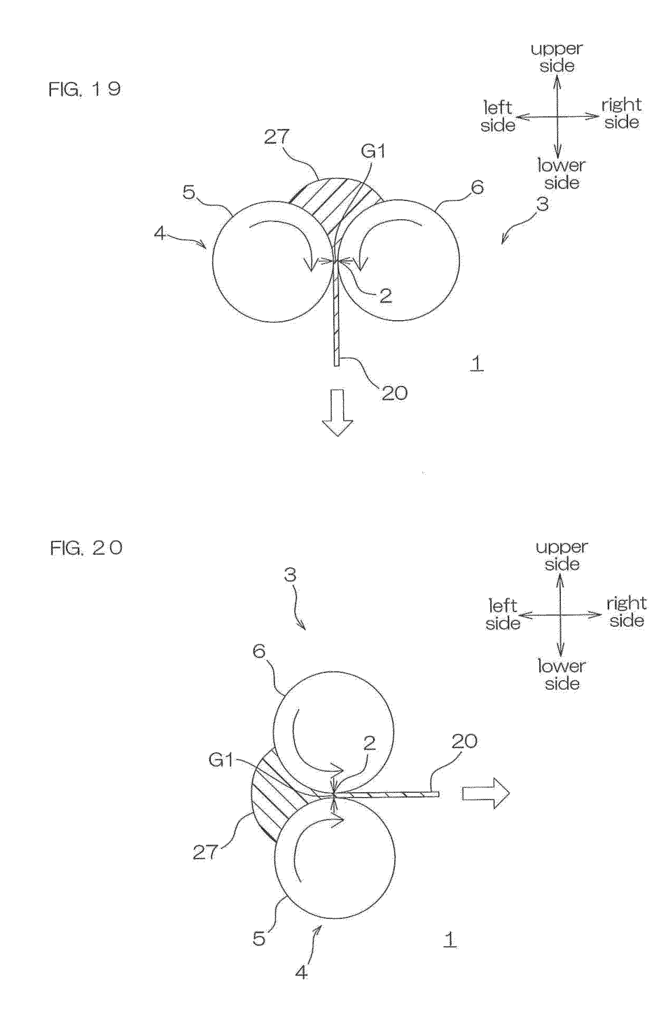

Furthermore, in FIG. 1, in the long-length sheet forming step, a calendering forming device provided with a plurality of the rolled members 4 is used as the calender 1. Alternatively, for example, as shown in FIG. 19, a calendering forming device provided with a single piece of the rolled member 4 is also capable of being used.

In FIG. 19, one pair of the rolls 3 constitutes a single piece of the rolled member 4 and is disposed in opposed relation to each other in the right-left direction.

In FIG. 19, one pair of the rolls 3 is disposed in opposed relation to each other in the right-left direction. Alternatively, for example, as shown in FIG. 20, one pair of the rolls 3 can be also disposed in opposed relation to each other in the right-left direction.

### Second Embodiment

A method for producing a thermally conductive sheet in the second embodiment includes the steps of preparing a material component (a material preparing step), forming a long-length sheet by extending the material component by applying pressure with a calender (a long-length sheet forming step), and pressing the long-length sheet (a pressing step).

Hereinafter, each of the steps is described in detail.

<Material Preparing Step>

The material preparing step in the second embodiment is the same as that in the first embodiment.

<Long-Length Sheet Forming Step>

Next, in this method, the above-described material component is extended by applying pressure with the calender, so that a thermally conductive sheet is formed.

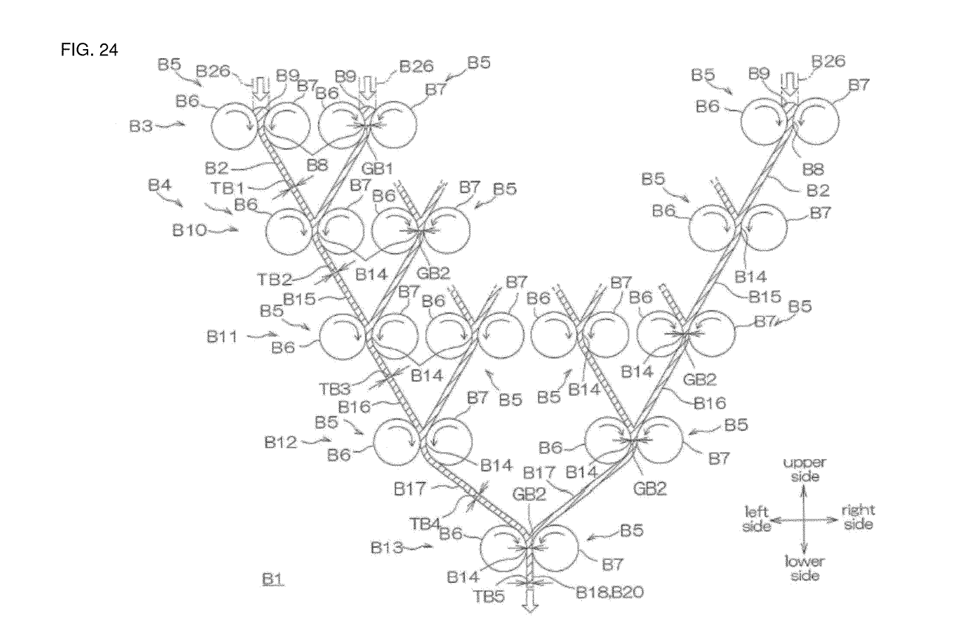

Next, the calender used in the long-length sheet forming step is described with reference to FIG. 24.

In FIG. 24, a calender B1 is provided with a sheet forming portion B3 in which a first long-length sheet B2 is formed from a material component B9 and a sheet laminated portion B4 in which a plurality of the first long-length sheets B2 are laminated in the thickness direction (the thickness direction of the first long-length sheet B2, hereinafter the same).

The sheet forming portion B3 is disposed at the most upstream side in the conveying direction (the up-down direction in FIG. 24, hereinafter, simply referred to as the conveying direction) of the first long-length sheet B2 in the calender B1 and includes a plurality of rolled members B5.

The sheet laminated portion B4 is disposed at the downstream side in the conveying direction with respect to the sheet forming portion B3. The sheet laminated portion B4 consists of a plurality of steps or a single step (“n” number of steps (“n” is an integer of 1 or more) of, for example, 1 to 9 steps, or preferably 2 to 6 steps (to be specific, 4 steps)) in the conveying direction.

The sheet forming portion B3 includes a plurality (2ⁿ pieces, to be specific, 16 pieces) of the rolled members B5 that are disposed in parallel in a direction perpendicular to the conveying direction.

Each of the rolled members B5 includes one pair of rolls disposed in opposed relation to each other so that a nip portion (hereinafter, defined as a first nip portion B8 in the sheet forming portion and a second nip portion B14 in the sheet laminated portion) is formed. The one pair of the rolls includes a first roll B6 that is disposed at one side in a parallel direction (a direction that crosses the conveying direction) and a second roll B7 that is disposed in opposed relation at the other side in the parallel direction with respect to the first roll B6.

The first roll B6 and the second roll B7 are made of, for example, a metal such as stainless steel, iron, or copper. The first roll B6 and the second roll B7 are preferably made of stainless steel. The surfaces of the first roll B6 and the second roll B7 can be also subjected to a release treatment.

The first roll B6 and the second roll B7 are formed to have a diameter of, for example, 80 mm or more, or preferably 100 mm or more, and of, for example, 1000 mm or less, or preferably 700 mm or less and to have a length in the axial direction of, for example, 100 mm or more, or preferably 200 mm or more, and of, for example, 3000 mm or less, or preferably 2000 mm or less.

A gap G1 of the first nip portion B8 of the first roll B6 and the second roll B7 is, for example, 0.05 mm or more, or preferably 0.1 mm or more, and is, for example, 10 mm or less, or preferably 0.5 mm or less.

The revolving rate of the first roll B6 and the second roll B7 is set within a range of, for example, 50 m/min or less, or preferably 10 m/min or less, and of, for example, 0.01 m/min or more.

The first roll B6 and the second roll B7 are heated by a heat source that is not shown as required. The surface temperature of the first roll B6 and the second roll B7 is set within a range of, for example, 20° C. or more, or preferably 40° C. or more, and of, for example, 150° C. or less, or preferably 80° C. or less.

The first roll B6 and the second roll B7 are provided so as to revolve in the same direction at the first nip portion B8 thereof so that the first long-length sheet B2 is capable of being conveyed toward the downstream side in the conveying direction.

The rolled member B5 forms the first long-length sheet B2 by forming the material component B9 into a sheet shape by being extended by applying pressure.

The sheet laminated portion B4 includes a first-step laminated portion and, if necessary, a plurality of middle-step laminated portions, and a final-step laminated portion. The sheet laminated portion B4 includes, in the case of consisting of “n” number of steps, for example, a first sheet laminated portion (the first-step laminated portion) and, if necessary, a second sheet laminated portion (the middle-step laminated portion), and the “n” sheet laminated portion (the final-step laminated portion). To be specific, in FIG. 24, the sheet laminated portion B4 includes a first sheet laminated portion B10 (the first-step laminated portion), a second sheet laminated portion B11 (the middle-step laminated portion), a third sheet laminated portion B12 (the middle-step laminated portion), and a fourth sheet laminated portion B13 (the final-step laminated portion).

The first sheet laminated portion B10 is disposed at the downstream side in the conveying direction with respect to the sheet forming portion B3 and is also disposed at the most upstream side in the conveying direction in the sheet laminated portion B4. The first sheet laminated portion B10 includes one piece of the rolled member B5 (corresponding to a second rolled member) that is disposed in parallel in a direction perpendicular to the conveying direction at the downstream side in the conveying direction with respect to a plurality of the rolled members B5 (corresponding to a first rolled member), in the sheet forming portion B3, which are disposed at the upstream side in the conveying direction.

To be specific, one piece of the rolled member B5 in the first sheet laminated portion B10 is provided corresponding to two pieces of the rolled members B5 in the sheet forming portion B3. In other words, half the number of pieces of the rolled member B5 in the first sheet laminated portion B10 is provided with respect to the number of pieces of the rolled member B5 in the sheet forming portion B3. When the sheet laminated portion B4 consists of “n” number of steps, the first sheet laminated portion B10 includes 2ⁿ⁻¹ pieces (to be specific, 8 pieces) of the rolled members B5.

The material, size, revolving rate, surface temperature, and revolving direction of the first roll B6 and the second roll B7 that form the rolled members B5 in the first sheet laminated portion B10 are the same as those of the rolled members B5 in the sheet forming portion B3.

A gap G2 of the second nip portion B14 of the first roll B6 and the second roll B7 in the first sheet laminated portion B10 with respect to the first gap G1 of the first nip portion B8 in the sheet forming portion B3 is, for example, 50% or more, preferably 70% or more, or more preferably 80% or more, and is, for example, 150% or less, preferably 130%, or more preferably 120%. To be specific, the gap G2 of the second nip portion B14 in the first sheet laminated portion B10 is, for example, 0.05 mm or more, preferably 0.05 mm or more, more preferably 0.1 mm or more, or further more preferably 0.15 mm or more, and is, for example, 1.5 mm or less, preferably 1 mm or less, more preferably 0.8 mm or less, or further more preferably 0.6 mm or less.

The second sheet laminated portion B11 is disposed at the downstream side in the conveying direction with respect to the first sheet laminated portion B10. The second sheet laminated portion B11 includes one piece of the rolled member B5 (corresponding to the second rolled member) that is disposed in parallel in a direction perpendicular to the conveying direction at the downstream side in the conveying direction with respect to a plurality of the rolled members B5 (corresponding to the first rolled member), in the first sheet laminated portion B10, which are disposed at the upstream side in the conveying direction.

To be specific, one piece of the rolled member B5 in the second sheet laminated portion B11 is provided corresponding to two pieces of the rolled members B5 in the first sheet laminated portion B10. In other words, half the number of pieces of the rolled member B5 in the second sheet laminated portion B11 is provided with respect to the number of pieces of the rolled member B5 in the first sheet laminated portion B10. When the sheet laminated portion B4 consists of “n” number of steps, the second sheet laminated portion B11 includes 2ⁿ⁻² pieces (to be specific, 4 pieces) of the rolled members B5.

The first roll B6 and the second roll B7 that form the rolled members B5 in the second sheet laminated portion B11 are the same as those in the first sheet laminated portion B10.

The third sheet laminated portion B12 is disposed at the downstream side in the conveying direction with respect to the second sheet laminated portion B11. The third sheet laminated portion B12 includes one piece of the rolled member B5 (corresponding to the second rolled member) that is disposed in parallel in a direction perpendicular to the conveying direction at the downstream side in the conveying direction with respect to a plurality of the rolled members B5 (corresponding to the first rolled member), in the second sheet laminated portion B11, which are disposed at the upstream side in the conveying direction.

To be specific, one piece of the rolled member B5 in the third sheet laminated portion B12 is provided corresponding to two pieces of the rolled members B5 in the second sheet laminated portion B11. In other words, half the number of pieces of the rolled member B5 in the third sheet laminated portion B12 is provided with respect to the number of pieces of the rolled member B5 in the second sheet laminated portion B11. When the sheet laminated portion B4 consists of “n” number of steps, the third sheet laminated portion B12 includes 2ⁿ⁻³ pieces (to be specific, 2 pieces) of the rolled members B5.

The first roll B6 and the second roll B7 that form the rolled members B5 in the third sheet laminated portion B12 are the same as those in the first sheet laminated portion B10.

The fourth sheet laminated portion B13 is disposed at the downstream side in the conveying direction with respect to the third sheet laminated portion B12 and is also disposed at the most downstream side in the conveying direction in the sheet laminated portion B4. The fourth sheet laminated portion B13 includes one piece of the rolled member B5 (corresponding to the second rolled member) that is disposed in parallel in a direction perpendicular to the conveying direction at the downstream side in the conveying direction with respect to a plurality of the rolled members B5 (corresponding to the first rolled member), in the third sheet laminated portion B12, which are disposed at the upstream side in the conveying direction.

To be specific, one piece of the rolled member B5 in the fourth sheet laminated portion B13 is provided corresponding to two pieces of the rolled members B5 in the third sheet laminated portion B12. In other words, half the number of pieces of the rolled member B5 in the fourth sheet laminated portion B13 is provided with respect to the number of pieces of the rolled member B5 in the third sheet laminated portion B12. When the sheet laminated portion B4 consists of “n” number of steps, the fourth sheet laminated portion B13 includes 2ⁿ⁻⁴ piece (to be specific, 1 piece) of the rolled member B5.

The first roll B6 and the second roll B7 that form the rolled members B5 in the fourth sheet laminated portion B13 are the same as those in the first sheet laminated portion B10.

In the calender B1, a winding roll (not shown) is provided at spaced intervals to the downstream side in the conveying direction of the rolled member B5 in the fourth sheet laminated portion B13 (when the sheet laminated portion B4 consists of “n” number of steps, the “n” sheet laminated portion) as required.

In order to form a long-length sheet B20 by extending the material component B9 by applying pressure with the calender B1, the material component B9 is extended by applying pressure with the first roll B6 and the second roll B7 in the sheet forming portion B3, so that the first long-length sheet B2 is formed. Next, a plurality of the first long-length sheets B2 are laminated in the thickness direction to be extended by applying pressure with the first roll B6 and the second roll B7 in the sheet laminated portion B4.

To be specific, the material component B9 is charged into each of the first nip portions B8 of a plurality of the rolled members B5 in the sheet forming portion B3.

The charged amount of the material component B9 is, for example, 0.01 kg/min or more, or preferably 0.02 kg/min or more, and is, for example, 50 kg/min or less, or preferably 5 kg/min or less.

Next, the material component B9 that is charged into each of the first nip portions B8 of a plurality of the rolled members B5 in the sheet forming portion B3 is, at the first nip portion B8, by the revolutions of the first roll B6 and the second roll B7, conveyed to the downstream side in the conveying direction, while being extended by applying pressure, to be formed into each of the first long-length sheets B2, and then, each of the long-length sheets B2 is sent from each of the rolled members B5 in the sheet forming portion B3.

A thickness TB1 of the first long-length sheet B2 formed by the rolled member B5 in the sheet forming portion B3 is, for example, 0.05 mm or more, or preferably 0.1 mm or more, and is, for example, 1 mm or less, preferably 0.8 mm or less, more preferably 0.6 mm or less, or further more preferably 0.4 mm or less.

The two pieces of the first long-length sheets B2 that are extended by applying pressure by the two pieces of the rolled members B5 that are adjacent to each other in the parallel direction in the sheet forming portion B3 are sent toward the one piece of the rolled member B5 in the first sheet laminated portion B10 that corresponds to the two pieces of the first long-length sheets B2. Thereafter, the two pieces of the first long-length sheets B2 reach the second nip portion B14 of the rolled member B5 in the first sheet laminated portion B10 to be unified and laminated and then, enter the second nip portion B14 in the first sheet laminated portion B10. Next, by the revolutions of the first roll B6 and the second roll B7, the two pieces of the first long-length sheets B2 that enter the second nip portion B14 are conveyed to the downstream side in the conveying direction (downwardly), while being collectively extended by applying pressure, so that one piece of a second long-length sheet B15 that is formed of two layers is formed to be sent from the rolled member B5 in the first sheet laminated portion B10.

A thickness TB2 of the second long-length sheet B15 formed by the rolled member B5 in the first sheet laminated portion B10 with respect to the thickness TB1 of the first long-length sheet B2 formed by rolling of the rolled member B5 in the sheet forming portion B3 is, for example, 150% or less, preferably 130% or less, or more preferably 120% or less, and is, for example, 50% or more, preferably 70% or more, or more preferably 80% or more.

To be specific, the thickness TB2 of the second long-length sheet B15 formed by the rolled member B5 in the first sheet laminated portion B10 is, for example, 0.05 mm or more, or preferably 0.1 mm or more, and is, for example, 1 mm or less, preferably 0.8 mm or less, more preferably 0.6 mm or less, or further more preferably 0.4 mm or less.

The two pieces of the second long-length sheets B15 that are extended by applying pressure by the two pieces of the rolled members B5 that are adjacent to each other in the parallel direction in the first sheet laminated portion B10 are sent toward the one piece of the rolled member B5 in the second sheet laminated portion B11 that corresponds to the two pieces of the second long-length sheets B15. Thereafter, the two pieces of the second long-length sheets B15 reach the second nip portion B14 of the rolled member B5 in the second sheet laminated portion B11 to be unified and laminated and then, enter the second nip portion B14 in the second sheet laminated portion B11. Next, by the revolutions of the first roll B6 and the second roll B7, the two pieces of the second long-length sheets B15 that enter the second nip portion B14 are conveyed to the downstream side in the conveying direction (downwardly), while being collectively extended by applying pressure, so that one piece of the third long-length sheet B16 that is formed of four layers is formed to be sent from the rolled member B5 in the second sheet laminated portion B11.

A thickness TB3 of the third long-length sheet B16 formed by the rolled member B5 in the second sheet laminated portion B11 with respect to the thickness TB2 of the second long-length sheet B15 formed by rolling of the rolled member B5 in the first sheet laminated portion B10 is, for example, 150% or less, preferably 130% or less, or more preferably 120% or less, and is, for example, 50% or more, preferably 70% or more, or more preferably 80% or more.

To be specific, the thickness TB3 of the third long-length sheet B16 formed by the rolled member B5 in the second sheet laminated portion B11 is, for example, 0.05 mm or more, or preferably 0.1 mm or more, and is, for example, 1 mm or less, preferably 0.8 mm or less, more preferably 0.6 mm or less, or further more preferably 0.4 mm or less.

The two pieces of the third long-length sheets B16 that are extended by applying pressure by the two pieces of the rolled members B5 that are adjacent to each other in the parallel direction in the second sheet laminated portion B11 are sent toward the one piece of the rolled member B5 in the third sheet laminated portion B12 that corresponds to the two pieces of the third long-length sheets B16. Thereafter, the two pieces of the third long-length sheets B16 reach the second nip portion B14 of the rolled member B5 in the third sheet laminated portion B12 to be unified and laminated and then, enter the second nip portion B14 in the third sheet laminated portion B12. Next, by the revolutions of the first roll B6 and the second roll B7, the two pieces of the third long-length sheets B16 that enter the second nip portion B14 are conveyed to the downstream side in the conveying direction (downwardly), while being collectively extended by applying pressure, so that one piece of a fourth long-length sheet B17 that is formed of eight layers is formed to be sent from the rolled member B5 in the third sheet laminated portion B12.

A thickness TB4 of the fourth long-length sheet B17 formed by the rolled member B5 in the third sheet laminated portion B12 with respect to the thickness TB3 of the third long-length sheet B16 formed by rolling of the rolled member B5 in the second sheet laminated portion B11 is, for example, 150% or less, preferably 130% or less, or more preferably 120% or less, and is, for example, 50% or more, preferably 70% or more, or more preferably 80% or more.

To be specific, the thickness TB4 of the fourth long-length sheet B17 formed by the rolled member B5 in the third sheet laminated portion B12 is, for example, 0.05 mm or more, or preferably 0.1 mm or more, and is, for example, 1 mm or less, preferably 0.8 mm or less, more preferably 0.6 mm or less, or further more preferably 0.4 mm or less.

The two pieces of the fourth long-length sheets B17 that are extended by applying pressure by the two pieces of the rolled members B5 that are adjacent to each other in the parallel direction in the third sheet laminated portion B12 are sent toward the one piece of the rolled member B5 in the fourth sheet laminated portion B13 that corresponds to the two pieces of the fourth long-length sheets B17. Thereafter, the two pieces of the fourth long-length sheets B17 reach the second nip portion B14 of the rolled member B5 in the fourth sheet laminated portion B13 to be unified and laminated and then, enter the second nip portion B14 in the fourth sheet laminated portion B13. Next, by the revolutions of the first roll B6 and the second roll B7, the two pieces of the fourth long-length sheets B17 that enter the second nip portion B14 are conveyed to the downstream side in the conveying direction (downwardly), while being collectively extended by applying pressure, so that one piece of a fifth long-length sheet B18 that is formed of 16 layers is formed to be sent from the rolled member B5 in the fourth sheet laminated portion B13.

A thickness TB5 of the fifth long-length sheet B18 formed by the rolled member B5 in the fourth sheet laminated portion B13 with respect to the thickness TB4 of the fourth long-length sheet B17 formed by rolling of the rolled member B5 in the third sheet laminated portion B12 is, for example, 150% or less, preferably 130% or less, or more preferably 120% or less, and is, for example, 50% or more, preferably 70% or more, or more preferably 80% or more.

To be specific, the thickness TB5 of the fifth long-length sheet B18 formed by the rolled member B5 in the fourth sheet laminated portion B13 is, for example, 0.05 mm or more, or preferably 0.1 mm or more, and is, for example, 1 mm or less, preferably 0.8 mm or less, more preferably 0.6 mm or less, or further more preferably 0.4 mm or less.

Thereafter, the fifth long-length sheet B18 sent from the rolled member B5 in the fourth sheet laminated portion B13 is wound up by a winding roll that is not shown.

In this way, the long-length sheet B20 is capable of being obtained.

<Pressing Step>

The pressing step in the second embodiment is the same as that of the first embodiment.

The properties and the like of a sheet B21 and a thermally conductive sheet B100 in the second embodiment are the same as those of the thermally conductive sheet 100 in the first embodiment.

The thermally conductive sheet B100 is attached to a heat dissipation object that serves as an adherend. Thereafter, when the polymer matrix contains a thermosetting resin component, the resulting thermally conductive sheet B100 is bonded to the heat dissipation object by being thermally cured by heating (being brought into a C-stage state).

In order to thermally cure the thermally conductive sheet B100, the thermally conductive sheet B100 is heated at, for example, 60° C. or more, or preferably 80° C. or more, and at, for example, 250° C. or less, or preferably 200° C. or less for, for example, 5 minutes or more, or preferably 10 minutes or more, and for, for example, 300 minutes or less, or preferably 200 minutes or less.

In the method for producing the thermally conductive sheet in the second embodiment, the material component B9 is extended by applying pressure with the calender B1 provided with the first roll B6 and the second roll B7, so that the fifth long-length sheet B18 is formed and in this way, the thermally conductive sheet B100 is capable of being obtained with excellent production efficiency.

Additionally, the material component B9 is extended by applying pressure with the calender B1, so that fracture of boron nitride particles B23 in a plate shape is capable of being effectively prevented.

The material component B9 is extended by applying pressure with the first roll B6 and the second roll B7 in the sheet forming portion B3, so that the first long-length sheet B2 is formed. Thereafter, with the first roll B6 and the second roll B7, a plurality of the first long-length sheets B2, a plurality of the second long-length sheets B15, a plurality of the third long-length sheets B16, and a plurality of the fourth long-length sheets 17 are laminated in the thickness direction TD and extended by applying pressure in the first sheet laminated portion B10, the second sheet laminated portion B11, the third sheet laminated portion B12, and the fourth sheet laminated portion B13, respectively, in the sheet laminated portion B4. Thereafter, furthermore, in order to press the long-length sheet, the porosity P is capable of being reduced, while the boron nitride particles B23 in a plate shape are oriented along the plane direction PD perpendicular to the thickness direction TD in a polymer matrix B24.

Thus, the porosity P is capable of being reduced, while the boron nitride particles B23 in a plate shape are efficiently oriented along the plane direction PD in the polymer matrix B24.

Thus, the thermally conductive sheet B100 having excellent thermally conductive properties and excellent flexibility in the plane direction PD is capable of being produced with excellent production efficiency.

As a result, the thermally conductive sheet B100 having excellent flexibility and excellent thermally conductive properties in the plane direction PD is capable of being used for various heat dissipation applications.

To be specific, when an electronic element is covered with the thermally conductive sheet B100, heat of the electronic element is capable of being efficiently thermally conducted, while the electronic element is capable of being protected.

The electronic element that is covered with the thermally conductive sheet B100 is not particularly limited and examples thereof include an IC (integrated circuit) chip, a condenser, a coil, a resistor, and a light emitting diode. These electronic elements are usually provided on a substrate and are disposed at spaced intervals to each other in the plane direction (the plane direction of the substrate).

Among all, when an electronic component used for power electronics and/or a mounted substrate on which the electronic component is mounted are/is covered with the thermally conductive sheet B100, heat of the electronic component and/or the mounted substrate is capable of being dissipated along the plane direction PD by the thermally conductive sheet B100, while deterioration of the thermally conductive sheet B100 by heat is capable of being prevented.

Examples of the electronic component used for power electronics include an IC (integrated circuit) chip (among all, a narrow-width electrode terminal portion in the IC chip), a thyristor (a rectifier), a motor component, an inverter, a power transmission component, a condenser, a coil, a resistor, and a light emitting diode.

The above-described electronic components are mounted on the surface (one surface) of the mounted substrate and the electronic components are disposed at spaced intervals to each other in the plane direction (the plane direction of the mounted substrate) in the mounted substrate.

The thermally conductive sheet B100 having excellent heat resistance is also capable of being provided in, for example, an LED heat dissipation substrate and a heat dissipating material for a battery.

In the embodiment shown by the solid lines in FIG. 24, the material component containing the solvent is dried and the material powder is prepared to be then charged into the calender B1. Alternatively, for example, as shown by the phantom lines in FIG. 24, after the material component containing the solvent is formed into a material sheet B26 with an extruder or the like, the material sheet B26 can be also charged into the calender B1.

In the embodiment in FIG. 24, one piece of the rolled member B5 that is disposed relatively at the downstream side in the conveying direction is provided corresponding to two pieces of the rolled members B5 that are disposed relatively at the upstream side in the conveying direction. Alternatively, though not shown, for example, one piece of the rolled member B5 that is disposed relatively at the downstream side in the conveying direction can be also provided corresponding to three or more pieces of the rolled members B5 that are disposed relatively at the upstream side in the conveying direction.

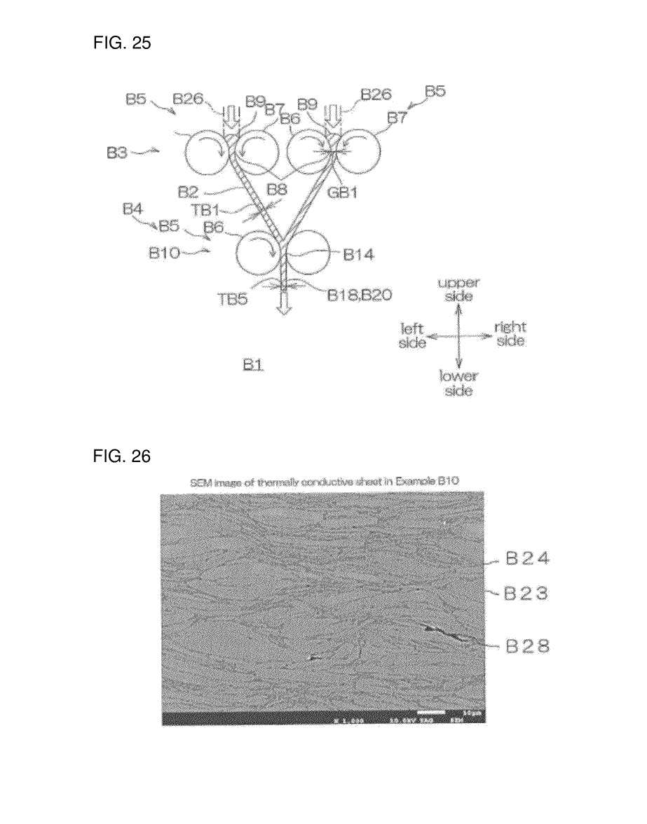

In the embodiment in FIG. 24, the steps of laminating the two pieces of the long-length sheets are performed by four times. The number of steps of laminating the long-length sheets is not particularly limited, however, and can be also performed by, for example, once (that is, the embodiment in which the sheet laminated portion has a single step, ref: FIG. 25) or more, preferably twice or more, or more preferably three times or more, and by, for example, 10 times or less, or preferably seven times or less.

When the number of steps of laminating the long-length sheets is below the above-described lower limit, the porosity may not be capable of being sufficiently reduced.

On the other hand, when the number of steps of laminating the long-length sheets is above the above-described upper limit, excellent production efficiency may not be capable of being obtained.

### EXAMPLES

The present invention will now be described in more detail by way of Examples and Comparative Examples. However, the present invention is not limited to the following Examples and Comparative Examples.

Values in Examples shown in the following can be replaced with the values (that is, the upper limit value or the lower limit value) described in the above-described embodiment.

In the following, Examples corresponding to the embodiments are shown and the present invention is described in detail.

### Examples 1 to 8 and Comparative Examples 1 to 15 Corresponding to First Embodiment

### Example 1

### Material Component Preparing Step

After components were blended in accordance with the mixing formulation described in Table 1 and stiffed, methyl ethyl ketone (a solvent) was distilled off by vacuum drying at 25° C. and in this way, a material component was prepared as a material powder (a mixing and vacuum drying method).

[Long-Length Sheet Forming Step] (Calender Forming: Rolled Member, Ref: FIG. 19)

Thereafter, as shown in FIG. 19, a calender provided with a single piece of a rolled member made of one pair of rolls was prepared.

Thereafter, the calender was operated under the forming conditions shown in Table 1 and the material component was charged from the upper side into a nip portion of the rolled member in the calender to be extended by applying pressure, so that a long-length sheet was produced.

When the material component was charged into the rolled member, the material component was sandwiched between two pieces of long-length release sheets (trade name: “PANA-PEEL TP-03”, made of PET, a thickness of 188 μm, manufactured by PANAC Corporation). The two pieces of the release sheets sandwiched the material component therebetween so that the treated surfaces thereof were opposed to each other, that is, faced inwardly.

The long-length sheet was in a B-stage state.

[Pressing Step]

The long-length sheet was cut into a rectangular shape having a 10 cm square to be formed. Thereafter, the two pieces of the release sheets were peeled. Thereafter, the obtained sheet was disposed on (on the upper surface of, to be specific, on the treated surface of) another release sheet (trade name: “PANA-PEEL SG-2”, made of PET, manufactured by PANAC Corporation) and furthermore, a spacer in a frame shape, made of brass, and in a size of 200 μm was disposed on the above-described release sheet (PANA-PEEL SG-2) on the periphery of the sheet. A release sheet (trade name: “PANA-PEEL SG-2”, made of PET, manufactured by PANAC Corporation) was disposed so as to cover the sheet and the spacer so that the treated surface thereof was opposed to the sheet and the spacer. That is, the sheet was sandwiched between the two pieces of the release sheets. In this way, a laminate made of the release sheet, the sheet, and the release sheet was prepared.

Thereafter, first, a silicone rubber sheet (a release sheet) in a plate shape was disposed in a vacuum pressing device and the laminate was disposed thereon. Furthermore, a silicone rubber sheet was disposed on the resulting laminate and subsequently, a vacuum was produced with the vacuum pressing device at 70° C. for 5 minutes at 50 Pa or less. Next, an effective pressure was adjusted to be 10 MPa and hot pressing was performed for 10 minutes to be thereafter depressurized. In this way, a thermally conductive sheet was obtained. The thermally conductive sheet was in a B-stage state and had a thickness of 258 μm.

### Examples 2 to 8 and Comparative Examples 1 to 15

Based on the mixing formulations and conditions described in Tables 1 to 6, thermally conductive sheets in Examples 2 to 8 and Comparative Examples 1 to 15 were obtained in the same manner as that in Example 1.

In Comparative Examples 1 to 7, a long-length sheet forming step was not performed with a calender. That is, in Comparative Examples 1, 3, and 5, a material powder was pressed. In Comparative Examples 2 and 4, a material powder was kneaded to be then pressed. Furthermore, in Comparative Example 6, a material powder was kneaded and extruded. In Comparative Example 7, a material powder was kneaded and extruded to be then pressed.

On the other hand, in Comparative Examples 8 to 15, a pressing step was not performed. That is, a long-length sheet forming step only was performed and the obtained long-length sheet was obtained as a thermally conductive sheet.

(Evaluation)

(1) Thermal Conductivity

The thermal conductivity of each of the thermally conductive sheets obtained in Examples and Comparative Examples was measured.

That is, the thermal conductivity in the plane direction (PD) was measured by a pulse heating method using a xenonflash analyzer “LFA-447” (manufactured by Erich NETZSCH GmbH & Co. Holding KG). The thermal conductivity in the thickness direction (TD) was measured by a TWA method using “ai-Phase mobile” (manufactured by ai-Phase Co., Ltd).

The results are shown in Tables 1 to 6.

(2) Observation of Cross Section with Electron Microscope

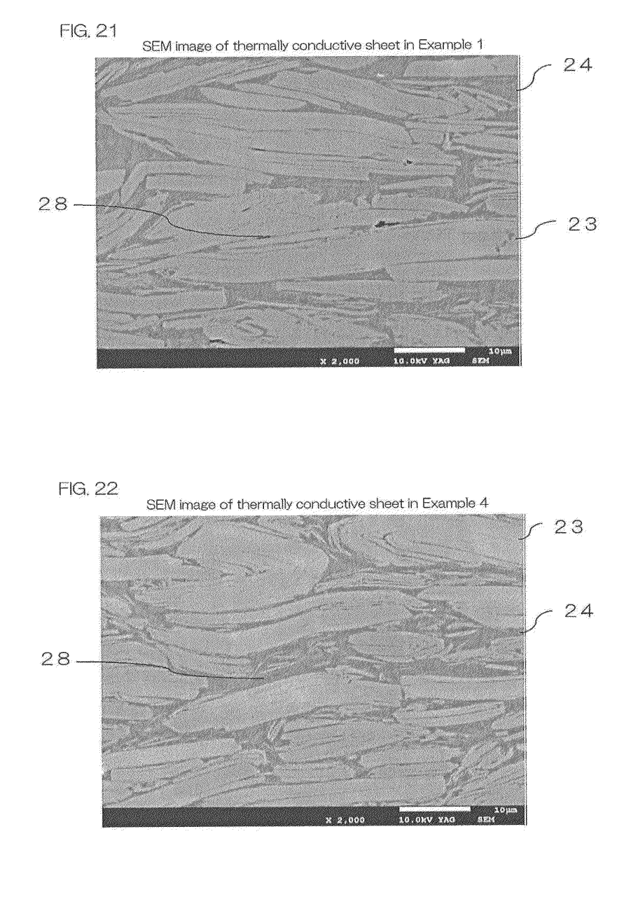

Each of the thermally conductive sheets in Examples 1 and 6 was cut along the thickness direction with a cross section polisher and the cross section thereof was observed with an electron microscope (SEM). The processed images are shown in FIGS. 21 and 22.

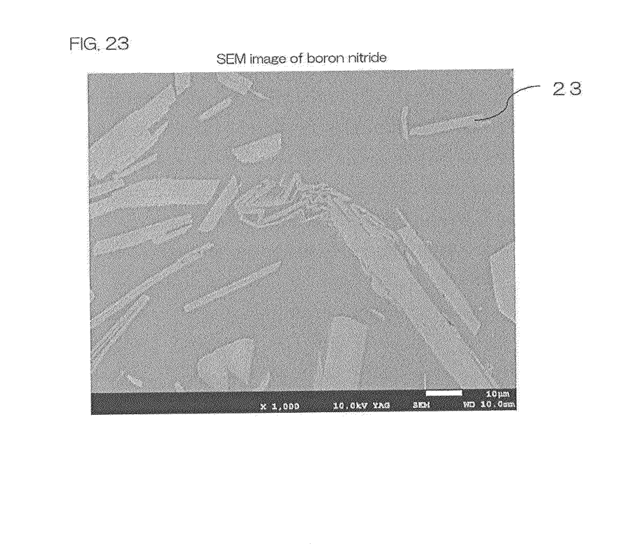

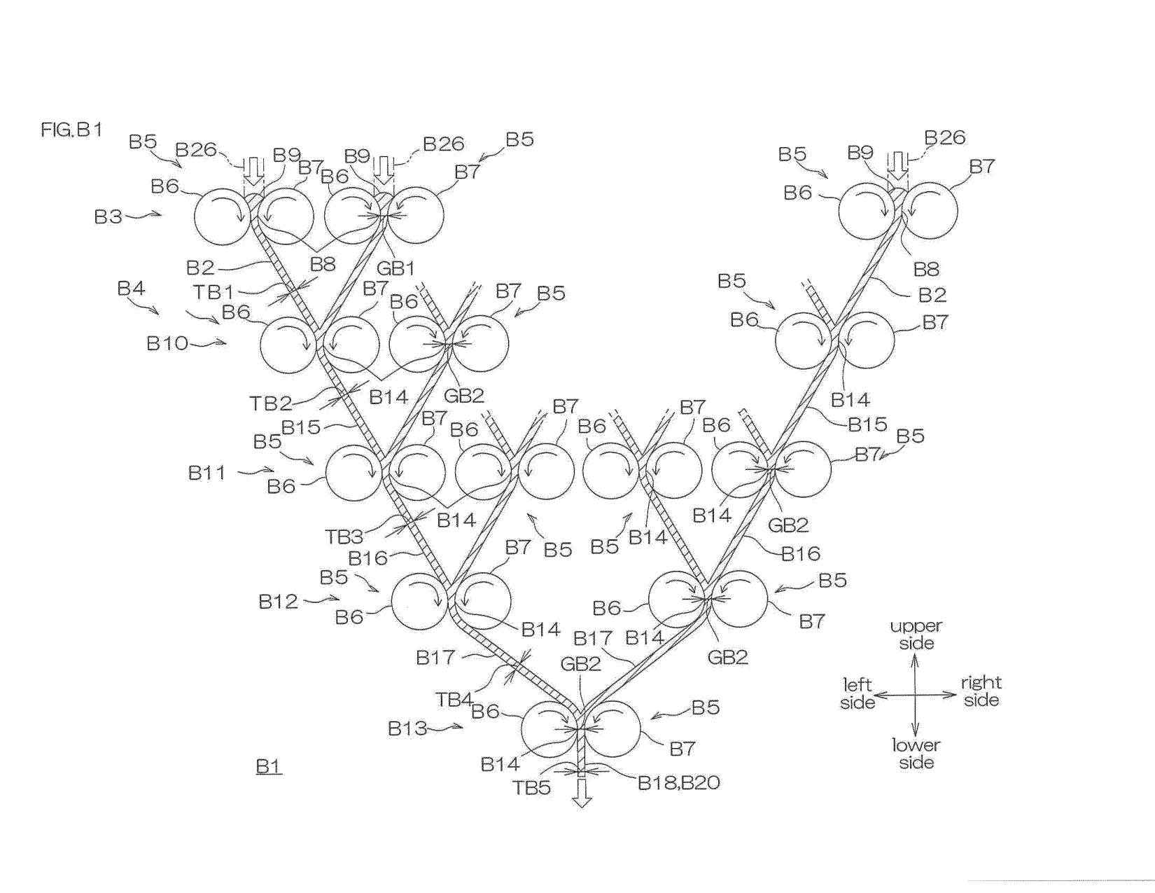

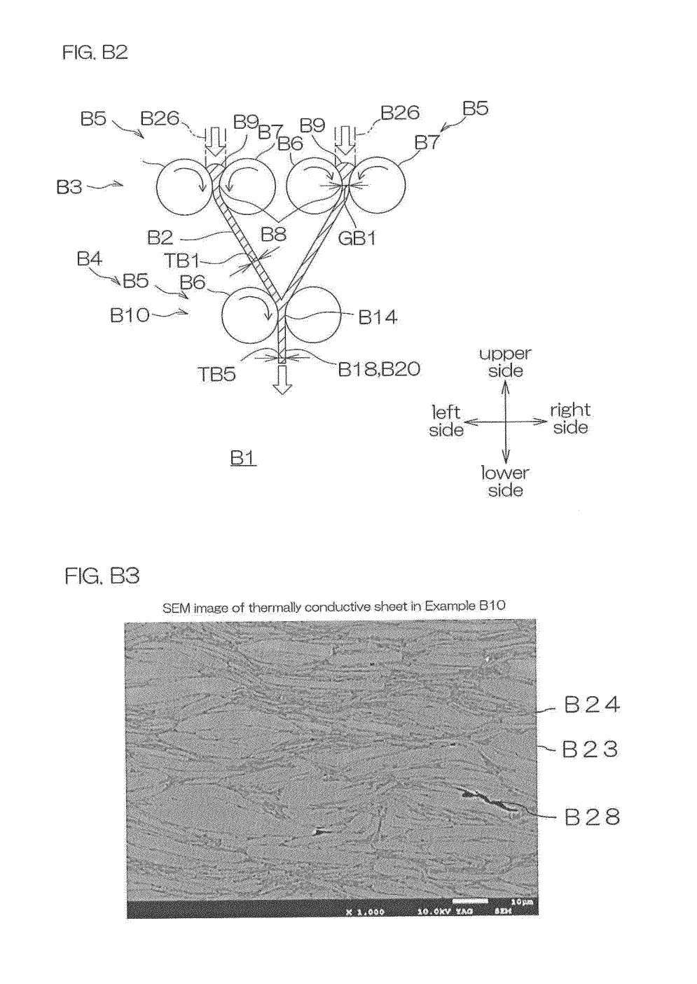

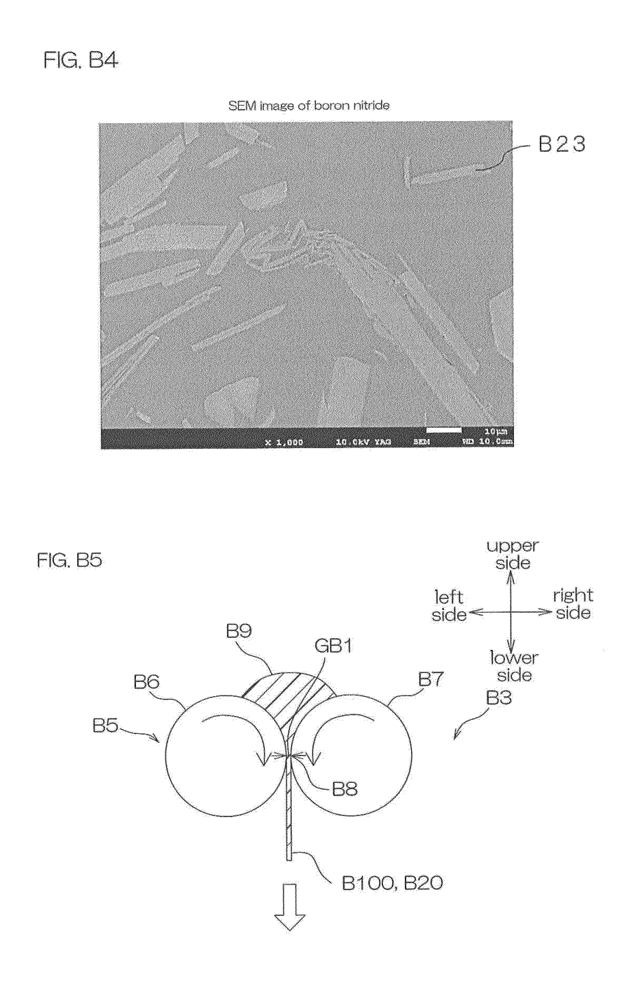

Boron nitride particles (PT-110) were also observed with an electron microscope (SEM). The processed image is shown in FIG. 23.

As a result, it is clear that in the boron nitride particles in the thermally conductive sheet in Example 1 shown in FIG. 21 and those in the thermally conductive sheet in Example 6 shown in FIG. 22, fracture is effectively prevented, compared to the boron nitride particles shown in FIG. 23.

(3) Bend Resistance (Flexibility)

A bend test in conformity with JIS K 5600-5-1 bend resistance (a cylindrical mandrel method) was performed for each of the thermally conductive sheets in Examples and Comparative Examples.

That is, bend resistance (flexibility) of each of the thermally conductive sheets in a B-stage state in Examples and Comparative Examples was evaluated under the following test conditions.

Test Conditions

Test Device: Type I

Mandrel: a diameter of 10 mm, a diameter of 5 mm, or a diameter of 1 mm

The thermally conductive sheet in a B-stage state was bent to a bending angle of above 90 degrees and 180 degrees or less and was evaluated as follows based on the diameter of a mandrel of a test device in which fracture (damage) was generated in the thermally conductive sheet.

The results are shown in Tables 1 to 6.

Excellent: fracture was not generated even when the thermally conductive sheet was bent with a mandrel having a diameter of 1 mm.

Good: fracture was not generated when the thermally conductive sheet was bent with a mandrel having a diameter of 5 mm, but fracture was generated when bent with a mandrel having a diameter of 1 mm.

Poor: fracture was not generated when the thermally conductive sheet was bent with a mandrel having a diameter of 10 mm, but fracture was generated when bent with a mandrel having a diameter of 5 mm.

Bad: fracture was generated when the thermally conductive sheet was bent with a mandrel having a diameter of 10 mm.

(4) Porosity (P)

The porosity (P) of each of the thermally conductive sheets in a B-stage state in Examples and Comparative Examples was measured by the following measurement method.

Measurement method of porosity: first, the volume and the weight of the thermally conductive sheet were measured and the density thereof was calculated. Furthermore, the density of the boron nitride particles was assumed to be 2.28 g/cm³ and the density of the resin was assumed to be 1.2 g/cm³, and a theoretical density of the thermally conductive sheet was calculated (in the case of 70 vol %, 1.956 g/cm³).

The results are shown in Tables 1 to 6.

(5) Complex Shear Viscosity (Complex Viscosity: η*)

The mixing formulations in Examples and Comparative Examples were classified into Formulations 1 to 3. The complex shear viscosity (complex viscosity) of the thermally conductive sheet in each of the Formulations was measured by a dynamic viscoelasticity measurement in a shear mode in conformity with JIS K7244-10 (in 2005) at a frequency of 10 Hz and a temperature rising rate of 2° C./min

The results are shown in Table 7.

<Formulations, Forming Conditions, and Properties of Thermally Conductive Sheets in Examples and Comparative Examples>

In the rows of “boron nitride particles” in Tables, values on the top represent the blended mass (g) of the boron nitride particles and values in parentheses at the bottom represent the volume percentage (vol %) of the boron nitride particles with respect to the thermally conductive sheet.

### Examples 1 to 8 and Comparative Examples 1 to 15 Corresponding to Second Embodiment

### Example B1

### Material Component Preparing Step

After components were blended in accordance with the mixing formulation described in Table B1 and stiffed, methyl ethyl ketone (a solvent) was distilled off by vacuum drying at 25° C. and in this way, a material component was prepared as a material powder (a mixing and vacuum drying method).

[Long-Length Sheet Forming Step] (Calender Forming: One-Step Sheet Forming Portion and Two-Step Sheet Laminated Portion, Ref: FIG. 25)

Thereafter, as shown in FIG. 25, a calender provided with a sheet forming portion made of two pairs of rolls and a sheet laminated portion made of one pair of rolls was prepared.

Thereafter, the calender was operated under the forming conditions shown in Table B1 and the material component was charged from the upper side into nip portions of two pieces of first rolled members in the sheet forming portion to be extended by applying pressure to be then continuously laminated by one pair of the rolls in the sheet laminated portion, so that a long-length sheet was produced.

When the material component was charged into each of the rolled members in the sheet forming portion, the material component was sandwiched between two pieces of long-length release sheets (trade name: “PANA-PEEL TP-03”, made of PET, a thickness of 188 μm, manufactured by PANAC Corporation). The two pieces of the release sheets sandwiched the material component therebetween so that the treated surfaces thereof were opposed to each other, that is, faced inwardly. Furthermore, the calender was made so that the release sheets that were adjacent to each other between the sheet forming portion and the sheet laminated portion were capable of being peeled from the long-length sheet.

The long-length sheet was in a B-stage state.

[Pressing Step]

The long-length sheet was cut into a rectangular shape having a 10 cm square to be formed. Thereafter, the two pieces of the release sheets were peeled. Thereafter, the obtained sheet was disposed on (on the upper surface of, to be specific, on the treated surface of) another release sheet (a polyester film (trade name: “PANA-PEEL SG-2”, manufactured by PANAC Corporation)) and furthermore, a spacer in a frame shape, made of brass, and in a size of 200 μm was disposed on the above-described release sheet (PANA-PEEL SG-2) on the periphery of the sheet. A release sheet (a polyester film (trade name: “PANA-PEEL SG-2”, manufactured by PANAC Corporation)) was disposed so as to cover the sheet and the spacer so that the treated surface thereof was opposed to the sheet. That is, the sheet was sandwiched between the two pieces of the release sheets. In this way, a laminate made of the release sheet, the sheet, and the release sheet was prepared.

Thereafter, first, a silicone rubber sheet in a plate shape was disposed in a vacuum pressing device and the laminate was disposed thereon. Furthermore, a silicone rubber sheet was disposed on the resulting laminate and subsequently, a vacuum was produced with the vacuum pressing device at 70° C. for 5 minutes at 50 Pa or less. Next, an effective pressure was adjusted to be 10 MPa and hot pressing was performed for 10 minutes to be thereafter depressurized. In this way, a thermally conductive sheet was obtained. The thermally conductive sheet was in a B-stage state and had a thickness of 258 μm.

### Examples B2 to B10 and Comparative Examples B1 to B20

Based on the mixing formulations and conditions described in Tables B1 to B6, thermally conductive sheets were obtained in the same manner as that in Example B1.

In Comparative Examples B1 to B7, a long-length sheet forming step by a calender was not performed. That is, in Comparative Examples B1, B3, and B5, a material powder was pressed. In Comparative Examples B2 and B4, a material powder was kneaded to be then pressed. Furthermore, in Comparative Example B6, a material powder was kneaded and extruded. In Comparative Example B7, a material powder was kneaded and extruded to be then pressed.

On the other hand, in Comparative Examples B8 to B20, a pressing step was not performed. That is, a long-length sheet forming step only was performed and the obtained long-length sheet was obtained as a thermally conductive sheet. In Comparative Examples B8, B13, and B15, the long-length sheet B20 was formed using a calender without a sheet laminated portion, that is, the calender B1 only provided with the sheet forming portion B3 made of one pair of rolls B6 and B7 shown in FIG. 28 and the obtained long-length sheet B20 was used as a thermally conductive sheet.

(Evaluation)

(1) Thermal Conductivity

The thermal conductivity of each of the thermally conductive sheets obtained in Examples B and Comparative Examples B was measured.

That is, the thermal conductivity in the plane direction (PD) was measured by a pulse heating method using a xenonflash analyzer “LFA-447” (manufactured by Erich NETZSCH GmbH & Co. Holding KG). The thermal conductivity in the thickness direction (TD) was measured by a TWA method using “ai-Phase mobile” (manufactured by ai-Phase Co., Ltd).

The results are shown in Table B1.

(2) Observation of Cross Section with Electron Microscope

The thermally conductive sheet in Example B10 was cut along the thickness direction with a cross section polisher and the cross section thereof was observed with an electron microscope (SEM). The processed image is shown in FIG. 26.

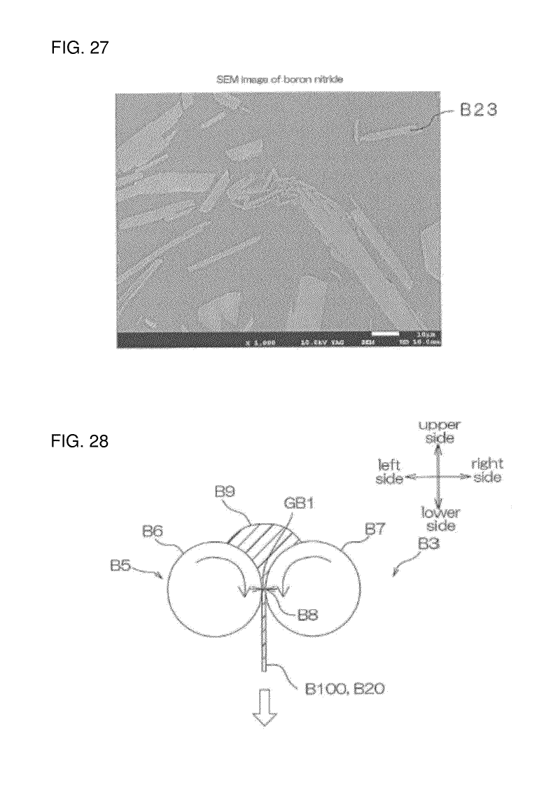

Boron nitride particles (PT-110) were also observed with an electron microscope (SEM). The processed image is shown in FIG. 27.

As a result, it is clear that in the boron nitride particles in the thermally conductive sheet in Example B10 shown in FIG. 26, fracture is effectively prevented, compared to the boron nitride particles shown in FIG. 27.

(3) Bend Resistance (Flexibility)

A bend test in conformity with JIS K 5600-5-1 bend resistance (a cylindrical mandrel method) was performed for each of the thermally conductive sheets in Examples B and Comparative Examples B.

That is, bend resistance (flexibility) of each of the thermally conductive sheets in a B-stage state in Examples B and Comparative Examples B was evaluated under the following test conditions.

Test Conditions

Test Device: Type I

Mandrel: a diameter of 10 mm, a diameter of 5 mm, or a diameter of 1 mm

The thermally conductive sheet in a B-stage state was bent to a bending angle of above 90 degrees and 180 degrees or less and was evaluated as follows based on the diameter of a mandrel of a test device in which fracture (damage) was generated in the thermally conductive sheet.

The results are shown in Tables B1 to B6.

Excellent: fracture was not generated even when the thermally conductive sheet was bent with a mandrel having a diameter of 1 mm

Good: fracture was not generated when the thermally conductive sheet was bent with a mandrel having a diameter of 5 mm, but fracture was generated when bent with a mandrel having a diameter of 1 mm

Poor: fracture was not generated when the thermally conductive sheet was bent with a mandrel having a diameter of 10 mm, but fracture was generated when bent with a mandrel having a diameter of 5 mm

Bad: fracture was generated when the thermally conductive sheet was bent with a mandrel having a diameter of 10 mm

(4) Porosity (P)

The porosity (P) of each of the thermally conductive sheets in a B-stage state in Examples and Comparative Examples was measured by the following measurement method.

Measurement method of porosity: first, the volume and the weight of the thermally conductive sheet were measured and the density thereof was calculated. Furthermore, the density of the boron nitride particles was assumed to be 2.28 g/cm³ and the density of the resin was assumed to be 1.2 g/cm³, and a theoretical density of the thermally conductive sheet was calculated (in the case of 70 vol %, 1.956 g/cm³).

The results are shown in Tables B1 to B6.

(5) Complex Shear Viscosity (Complex Viscosity: η*)

The mixing formulations in Examples B and Comparative Examples B were classified into Formulations B1 to B3. The complex shear viscosity (complex viscosity) of the thermally conductive sheet in each of the Formulations was measured by a dynamic viscoelasticity measurement in a shear mode in conformity with JIS K7244-10 (in 2005) at a frequency of 10 Hz and a temperature rising rate of 2° C./min.

The results are shown in Table B7.

<Formulations, Forming Conditions, and Properties of Thermally Conductive Sheets in Examples B and Comparative Examples B>

In the rows of “boron nitride particles” in Tables, values at the top represent the blended mass (g) of the boron nitride particles and values in parentheses at the bottom represent the volume percentage (vol %) of the boron nitride particles with respect to the thermally conductive sheet.

Abbreviations in Tables B1 to B6 are described in detail in the following.

PT-110: trade name, boron nitride particles in a plate shape, an average particle size (a light scattering method) of 45 μm, manufactured by Momentive Performance Materials Inc.

EG-200: trade name: “OGSOL EG-200”, a bisarylfluorene epoxy resin, a semi-solid state, an epoxy equivalent of 292 g/eqiv., a semi-solid state at a normal temperature, manufactured by Osaka Gas Chemicals Co., Ltd.

EXA-1000: trade name: “EPICLON EXA-4850-1000”, a bisphenol A epoxy resin, an epoxy equivalent of 310 to 370 g/eqiv., a liquid state at a normal temperature, a viscosity (at 25° C.) of 100,000 mPa·s, manufactured by DIC Corporation

HP-7200: trade name: “EPICLON HP-7200”, a dicyclopentadiene epoxy resin, an epoxy equivalent of 254 to 264 g/equiv., a solid state at a normal temperature, a softening point of 56 to 66° C., manufactured by DIC Corporation

MEH-7800-SS: trade name, a phenol-aralkyl resin, a curing agent, a hydroxyl group equivalent of 173 to 177 g/eqiv., manufactured by MEIWA PLASTIC INDUSTRIES, LTD.

2P4MHZ-PW: a 5 mass % methyl ethyl ketone dispersion liquid of trade name: “Curezol 2P4MHZ-PW” (a curing agent, an imidazole compound, manufactured by Shikoku Chemicals Corporation)

SG-P3 (a 15 mass % MEK solution): trade name: “Teisan Resin SG-P3”, an epoxy-modified ethyl acrylate-butyl acrylate-acrylonitrile copolymer, solvent: methyl ethyl ketone, a content ratio of rubber component of 15 mass %, a weight average molecular weight of 850,000, an epoxy equivalent of 210 eqiv./g, a theoretical glass transition temperature of 12° C., manufactured by Nagase ChemteX Corporation

2MAOK-PW: a 2,4-diamino-6-[2′-methylimidazolyl-(1′)]-ethyl-s-triazine isocyanuric acid adduct, a curing accelerator, manufactured by Shikoku Chemicals Corporation

TP03: trade name: “PANA-PEEL TP-03”, a release sheet made of PET, a thickness of 188 μm, manufactured by PANAC Corporation

MRF38: trade name: “DIAFOIL MRF38”, a release sheet made of PET, a thickness of 38 μm, manufactured by Mitsubishi Chemical Corporation

TABLE 1

| | | | | Ex. 1 | Ex. 2 | Ex. 3 | Ex. 4 |
|---|---|---|---|---|---|---|---|
| Formulation | BN | PT-110 | | 1000 (70) | 1000 (70) | 402.5 (70) | 15000 (70) |
| | Epoxy Resin | EG-200 | | — | — | 90 | — |
| | | EXA-1000 | | 22 | 22 | — | 327 |
| | | HP7200 | | 22 | 22 | — | 327 |
| | Curing Agent | Phenol Compound | MEH-7200-SS | 66 | 66 | — | 995 |
| | | Imidazole Compound | 2P4MHZ-PW | — | — | 0.9 | — |
| | Acrylic Resin | SG-P3 (15 mass % MEK solution) | | 762 | 762 | — | 11430 |
| | Curing | 2MAOK-PW | | 436 | 436 | — | 65 |
| | Accelerator | | | | | | |
| | Formulation | | | Formulation 1 | Formulation 1 | Formulation 3 | Formulation 1 |
| | Preparing Method of Material Powder | | | Mixing and | Mixing and | Mixing and | Tumbling |
| | | | | Vacuum | Vacuum | Vacuum | Fluidized Bed |
| | | | | Drying | Drying | Drying | Granulation |
| | | | | Method | Method | Method | Method |
| Forming | Forming Method | | | Calendar + | Calender + | Calender + | Calender + |
| Conditions | | | | Pressing | Pressing | Pressing | Pressing |
| | Long-Length | Release Sheet | | TP03 | TP03 | MRF38 | TP03 |
| | Sheet Forming | Number of | (Number of | 1 | 2 | 1 | 1 |
| | Step | Rolling times | Rolled Member) | | | | |
| | | Corresponding FIG. | | FIG. 19 | FIG. 1 | FIG. 19 | FIG. 19 |
| | | First Rolled | Gap [mm] | 0.35 | 0.35 | 0.35 | 0.35 |
| | | Member | | | | | |
| | | Second Rolled | Gap [mm] | — | 0.30 | — | — |
| | | Member | | | | | |
| | | Third Rolled | Gap [mm] | — | — | — | — |
| | | Member | | | | | |
| | | Fourth Rolled | Gap [mm] | — | — | — | — |
| | | Member | | | | | |
| | | Fifth Rolled | Gap [mm] | — | — | — | — |
| | | Member | | | | | |
| | | Roll | Revolving Rate | 0.3 | 0.5 | 0.3 | 0.3 |
| | | | [m/min] | | | | |
| | | | Surface | 70° C. | 70° C. | 80° C. | 80° C. |
| | | | Temperature [° C.] | | | | |
| | Pressing | Release Sheet | Type | SG2 | SG2 | SG2 | SG2 |
| | Step | Release Sheet | Thickness [μm] | 50 | 50 | 50 | 50 |
| | | Spacer | Thickness [mm] | 0.2 | 0.2 | 0.2 | 0.2 |
| | | Number of Pressing | [times] | 1 | 1 | 1 | 1 |
| | | Pressing Pressure | [MPa] | 60 | 60 | 60 | 60 |
| | | Pressing Duration | [min] | 10 | 10 | 10 | 10 |
| | | Pressing Temperature | [° C.] | 70 | 70 | 40 | 70 |
| Properties | Density | | g/cm³ | 1.919 | 1.921 | 1.897 | 1.943 |
| of | Thickness | | μm | 258 | 279 | 260 | 214 |
| Themally | Thermal | [W/m · K] | Plane Direction | 28.0 | 27.0 | 23.9 | 22.0 |
| Conductive | Conductivity | | Thickness Direction | 2.28 | 1.70 | 2.08 | 1.76 |

| | | | | | | |
|---|---|---|---|---|---|---|
| Sheet | Flexibility | Bend Resistance | Excellent | Good | Excellent | Excellent |
| | Porosity P | [vol %] | 1.9 | 1.8 | 3.0 | 0.7 |

TABLE 2

| | | | | Ex. 5 | Ex. 6 | Ex. 7 | Ex. 8 |
|---|---|---|---|---|---|---|---|
| Formulation | BN | PT-110 | | 600 (70) | 15000 (70) | 15000 (70) | 15000 (70) |
| | Epoxy Resin | EG-200 | | 44.24 | — | — | — |
| | | EXA-1000 | | — | 327 | 327 | 327 |
| | | HP7200 | | — | 327 | 327 | 327 |
| | Curing Agent | Phenol Compound | MEH-7800-SS | 19.9 | 99.5 | 99.5 | 99.5 |
| | | Imidazole Compound | 2P4MHZ-PW | — | — | — | — |
| | Acrylic Resin | SG-P3 (15 mass % MEK solution) | | 457 | 11430 | 11430 | 11430 |
| | Curing Accelerator | 2MAOK-PW | | 4.424 | 65 | 65 | 65 |
| | Formulation | | | Formulation 2 | Formulation 1 | Formulation 1 | Formulation 1 |
| | Preparing Method of Material Powder | | | Tumbling | Tumbling | Tumbling | Tumbling |
| | | | | Fluidized Bed | Fluidized Bed | Fluidized Bed | Fluidized Bed |
| | | | | Granulation | Granulation | Granulation | Granulation |
| | | | | Method | Method | Method | Method |
| Forming | Forming | | | Calender + | Calender + | Calender + | Calender + |
| Conditions | Method | | | Pressing | Pressing | Pressing | Pressing |
| | Long-Length | Release Sheet | | TP03 | TP03 | TP03 | TP03 |
| | Sheet | Number of | (Number of | 1 | 5 | 4 | 4 |
| | Forming | rolling [times] | Rolled Member) | | | | |
| | Step | Corresponding FIG. | | FIG. 19 | FIG. 1 | FIG. 1 | FIG. 1 |
| | | First Rolled | Gap [mm] | 0.35 | 0.35 | 0.35 | 0.35 |
| | | Member | | | | | |
| | | Second Rolled | Gap [mm] | — | 0.30 | 0.30 | 0.30 |
| | | Member | | | | | |
| | | Third Rolled | Gap [mm] | — | 0.25 | 0.25 | 0.25 |
| | | Member | | | | | |
| | | Fourth Rolled | Gap [mm] | — | 0.20 | 0.20 | 0.20 |
| | | Member | | | | | |
| | | Fifth Rolled | Gap [mm] | — | 0.15 | — | — |
| | | Member | | | | | |
| | | Roll | Revolving Rate [m/min] | 0.3 | 0.5 | 0.5 | 0.5 |
| | | | Surface | 70° C. | 60° C. | 80° C. | 90° C. |
| | | | Temperature [° C.] | | | | |
| | Pressing Step | Release Sheet | Type | SG2 | SG2 | SG2 | SG2 |
| | | Release Sheet | Thickness [μm] | 50 | 50 | 50 | 50 |
| | | Spacer | Thickness [mm] | 0.2 | 0.2 | 0.2 | 0.2 |
| | | Number of Pressing | [times] | 1 | 1 | 1 | 1 |
| | | Pressing Pressure | [MPa] | 60 | 60 | 60 | 60 |
| | | Pressing Duration | [min] | 10 | 10 | 10 | 10 |
| | | Pressing Temperature | [° C.] | 70 | 70 | 70 | 70 |
| Properties of | Density | | g/cm³ | 1.935 | 1.94 | 1.939 | 1.929 |
| Thermally | Thickness | | μm | 217 | 228 | 247 | 224 |
| Conductive | Thermal | [W/m · K] | Plane Direction | 21.1 | 27.0 | 25.1 | 25.6 |
| Sheet | Conductivity | | Thickness Direction | 1.69 | 1.58 | 1.81 | 1.49 |

| | | | | | |
|---|---|---|---|---|---|
| Flexibility | Bend Resistance | Excellent | Good | Good | Good |
| Porosity P | [vol %] | 1.1 | 0.8 | 0.9 | 1.4 |

TABLE 3

| | | | | Comp. Ex. 1 | Comp. Ex. 2 | Comp. Ex. 3 | Comp. Ex. 4 |
|---|---|---|---|---|---|---|---|
| Formulation | BN | PT-110 | | 1000 (70) | 1000 (70) | 15000 (70) | 15000 (70) |
| | Epoxy Resin | EG-200 | | — | — | — | — |
| | | EXA-1000 | | 22 | 22 | 327 | 327 |
| | | HP7200 | | 22 | 22 | 327 | 327 |
| | Curing Agent | Phenol | MEH-7800-SS | 66 | 66 | 995 | 995 |
| | | Compound | | | | | |
| | | Imidazole | 2P4MHZ-PW | — | — | — | — |
| | | Compound | | | | | |
| | Acrylic Resin | SG-P3 (15 mass % MEK solution) | | 762 | 762 | 11430 | 11430 |
| | Curing | 2MAOK-PW | | 436 | 436 | 65 | 65 |
| | Accelerator | | | | | | |
| | Formulation | | | Formulation 1 | Formulation 1 | Formulation 1 | Formulation 1 |
| | Preparing Method of Material Powder | | | Missing Vacuum | Missing Vacuum | Tumbling | Tumbling |
| | | | | Drying | Drying | Fluidized Bed | Fluidized Bed |
| | | | | Method | Method | Granulation Method | Granulation Method |
| Forming | Forming | | | Pressing | Kneading + | Pressing | Kneading + |
| Conditions | Method | | | | Pressing | | Pressing |
| | Long-Length | Release Sheet | | — | (Kneading) | — | (Kneading) |
| | Sheet Forming | Number of | (Number of | | | | |
| | Step | Rolling [times] | Rolled Member) | | | | |
| | | Corresponding FIG. | | | | | |
| | | First Rolled | Gap [mm] | | | | |
| | | Member | | | | | |
| | | Second Rolled | Gap [mm] | | | | |
| | | Member | | | | | |
| | | Third Rolled | Gap [mm] | | | | |
| | | Member | | | | | |
| | | Fourth Rolled | Gap [mm] | | | | |
| | | Member | | | | | |
| | | Fifth Rolled | Gap [mm] | | | | |
| | | Member | | | | | |
| | | Roll | Revolving Rate | | | | |
| | | | [m/min] | | | | |
| | | | Surface | | | | |
| | | | Temperature | | | | |
| | | | [° C.] | | | | |
| | Pressing Step | Release Sheet | Type | MRF38 | MRF38 | MRF38 | MRF38 |
| | | Release Sheet | Thickness [μm] | 38 | 38 | 38 | 38 |
| | | Spacer | Thickness [mm] | Absence | Absence | Absence | Absence |
| | | Number of | [times] | 1 | 1 | 1 | 1 |
| | | Pressing | | | | | |
| | | Pressing | [MPa] | 30 | 30 | 30 | 30 |
| | | Pressure | | | | | |
| | | Pressing | [min] | 15 | 15 | 15 | 15 |
| | | Duration | | | | | |
| | | Pressing | [° C.] | 80 | 80 | 80 | 80 |
| | | Temperature | | | | | |
| Properties of | Density | | g/cm³ | 1.889 | 1.885 | 1.825 | 1.894 |
| Thermally | Thickness | | μm | 246 | 283 | 239 | 269 |
| Conductive | Thermal | [W/m · K] | Plane Direction | 21.2 | 25.9 | 16.0 | 19.1 |
| Sheet | Conductivity | | Thickness | 2.49 | 1.54 | 3.01 | 2.33 |
| | | | Direction | | | | |

| | | | | | |
|---|---|---|---|---|---|
| Flexibility | Bend Resistance | Excellent | Poor | Excellent | Poor |
| Porosity P | [vol %] | 3.4 | 3.6 | 6.7 | 3.2 |

TABLE 4

| | | | | Comp. Ex. 5 | Comp. Ex. 6 | Comp. Ex. 7 | Comp. Ex. 8 |
|---|---|---|---|---|---|---|---|
| Formulation | BN | PT-110 | | 402.5 (70) | 402.5 (70) | 402.5 (70) | 1000 (70) |
| | Epoxy Resin | EG-200 | | 90 | 90 | 90 | — |
| | | EXA-1000 | | — | — | — | 22 |
| | | HP7200 | | — | — | — | 22 |
| | Curing Agent | Phenol | MEH-7800-SS | — | — | — | 66 |
| | | Compound | | | | | |
| | | Imidazole | 2P4MHZ-PW | 0.9 | 0.9 | 0.9 | — |
| | | Compound | | | | | |
| | Acrylic Resin | SG-P3 (15 mass % MEK solution) | | — | — | — | 762 |
| | Curing Accelerator | 2MAOK-PW | | — | — | — | 4.36 |
| | Formulation | | | Formulation 3 | Formulation 3 | Formulation 3 | Formulation 1 |
| | Preparing Method of Material Powder | | | Mixing and | Mixing and | Mixing and | Mixing and |
| | | | | Vacuum | Vacuum | Vacuum | Vacuum |
| | | | | Drying Method | Drying Method | Drying Method | Drying Method |
| Forming | Forming Method | | | Pressing | Kneading and | Kneading and | Calendar |
| Conditions | | | | | Extruding*1 | Extruding*1 + | |
| | | | | | | Pressing | |
| | Long-Length | Release Sheet | | — | (Kneading and | (Kneading and | TP03 |
| | Sheet Forming | | | | Extruding*1) | Extruding*1) | |
| | Step | Number of | (Number of | | | | 1 |
| | | Rolling [times] | Rolled Member) | | | | |
| | | Corresponding FIG. | | | | | FIG. 19 |
| | | First Rolled | Gap [mm] | | | | 0.35 |
| | | Member | | | | | |
| | | Second Rolled | Gap [mm] | | | | — |
| | | Member | | | | | |
| | | Third Rolled | Gap [mm] | | | | — |
| | | Member | | | | | |
| | | Fourth Rolled | Gap [mm] | | | | — |
| | | Member | | | | | |
| | | Fifth Rolled | Gap [mm] | | | | — |
| | | Member | | | | | |
| | | Roll | Revolving Rate | | | | 0.3 |
| | | | [m/min] | | | | |
| | | | Surface | | | | 70° C. |
| | | | Temperature | | | | |
| | | | [° C.] | | | | |
| | Pressing Step | Release Sheet | Type | MRF38 | — | SG2 | — |
| | | Release Sheet | Thickness [μm] | 38 | | 50 | |
| | | Spacer | Thickness [mm] | Absence | | 0.2 | |
| | | Number of | [times] | 1 | | 1 | |
| | | Pressing | | | | | |
| | | Pressing Pressure | [MPa] | 30 | | 60 | |
| | | Pressing Duration | [min] | 15 | | 10 | |
| | | Pressing | [° C.] | 80 | | 70 | |
| | | Temperature | | | | | |
| Properties of | Density | | g/cm³ | 1.82 | 1.749 | 1.807 | 1.749 |
| Thermally | Thickness | | μm | 248 | 1591 | 273 | 296 |
| Conductive | Thermal | [W/m · K] | Plane Direction | 16.2 | 6.0 | 18.6 | 23.6 |
| Sheet | Conductivity | | Thickness | 3.23 | 2.74 | 1.83 | 1.80 |
| | | | Direction | | | | |

| | | | | | |
|---|---|---|---|---|---|
| Flexibility | Bend Resistance | Excellent | Bad | Excellent | Excellent |
| Porosity P | [vol %] | 7.0 | 10.6 | 7.6 | 10.6 |

*1Extruding Conditions: Extruding rate of 0.4 m/min, Extruding Temperature of 60 to 80° C.

TABLE 5

| | | | | Comp. Ex. 9 | Comp. Ex. 10 | Comp. Ex. 11 | Comp. Ex. 12 |
|---|---|---|---|---|---|---|---|
| Formulation | BN | PT-110 | | 1000 (70) | 15000 (70) | 600 (70) | 15000 (70) |
| | Epoxy Resin | EG-200 | | — | — | 44.24 | — |
| | | EXA-1000 | | 22 | 327 | — | 327 |
| | | HP7200 | | 22 | 327 | — | 327 |
| | Curing Agent | Phenol Compound | MEH-7800-SS | 66 | 99.5 | 19.9 | 99.5 |
| | | Imidazole Compound | 2P4MHZ-PW | — | — | — | — |
| | Acrylic Resin | SG-P3 (15 mass % MEK solution) | | 762 | 11430 | 457 | 11430 |
| | Curing Accelerator | 2MAOK-PW | | 4.36 | 65 | 4.424 | 65 |
| | Formulation | | | Formula- | Formula- | Formula- | Formula- |
| | | | | tion 1 | tion 1 | tion 2 | tion 1 |
| | Preparing Method of Material Powder | | | Mixing and | Tumbling | Tumbling | Tumbling |
| | | | | Vacuum | Fluidized | Fluidized | Fluidized |
| | | | | Drying | Bed | Bed | Bed |
| | | | | Method | Granulation | Granulation | Granulation |
| | | | | | Method | Method | Method |
| Forming | Forming Method | | | Calendar | Calendar | Calendar | Calendar |
| Conditions | Long-Length | Release Sheet | | TP03 | TP03 | TP03 | TP03 |
| | Sheet | Number of | (Number of | 2 | 1 | 1 | 5 |
| | Forming | Rolling [times] | Rolled Member) | | | | |
| | Step | Corresponding FIG. | | FIG. 1 | FIG. 19 | FIG. 19 | FIG. 1 |
| | | First Rolled Member | Gap [mm] | 0.35 | 0.35 | 0.35 | 0.35 |
| | | Second Rolled Member | Gap [mm] | 0.30 | — | — | 0.30 |
| | | Third Rolled Member | Gap [mm] | — | — | — | 0.25 |
| | | Fourth Rolled Member | Gap [mm] | — | — | — | 0.20 |
| | | Fifth Rolled Member | Gap [mm] | — | — | — | 0.15 |
| | | Roll | Revolving Rate | 0.5 | 0.3 | 0.3 | 0.5 |
| | | | [m/min] | | | | |
| | | | Surface | 70° C. | 70° C. | 70° C. | 60° C. |
| | | | Temperature [° C.] | | | | |
| | Pressing Step | Release Sheet | Type | — | — | — | — |
| | | Release Sheet | Thickness [μm] | | | | |
| | | Spacer | Thickness [mm] | | | | |
| | | Number of Pressing | [times] | | | | |
| | | Pressing Pressure | [MPa] | | | | |
| | | Pressing Duration | [min] | | | | |
| | | Pressing Temperature | [° C.] | | | | |
| Properties of | Density | | g/cm³ | 1.798 | 1.69 | 1.756 | 1.755 |
| Thermally | Thickness | | μm | 144 | 322.1 | 188 | 252 |
| Conductive | Thermal | [W/m · K] | Plane Direction | 17.2 | 15.5 | 12.4 | 16.5 |
| Sheet | Conductivity | | Thickness Direction | 0.99 | 1.12 | 0.94 | 1.04 |

| | | | | | |
|---|---|---|---|---|---|
| Flexibility | Bend Resistance | Good | Excellent | Excellent | Good |
| Porosity P | [vol %] | 8.1 | 13.6 | 10.2 | 10.3 |

TABLE 6

| | | | | Comp. Ex. 13 | Comp. Ex. 14 | Comp. Ex. 15 |
|---|---|---|---|---|---|---|
| Formulation | BN | PT-110 | | 15000 (70) | 15000 (70) | 15000 (70) |
| | Epoxy Resin | EG-200 | | — | — | — |
| | | EXA-1000 | | 327 | 327 | 327 |
| | | HP7200 | | 327 | 327 | 327 |
| | Curing Agent | Phenol Compound | MEH-7800-SS | 995 | 995 | 995 |
| | | Imidazole Compound | 2P4MHZ-PW | — | — | — |
| | Acrylic Resin | SG-P3 (15 mass % MEK solution) | | 11430 | 11430 | 11430 |
| | Curing Accelerator | 2MAOK-PW | | 65 | 65 | 65 |
| | Formulation | | | Formulation 1 | Formulation 1 | Formulation 1 |
| | Preparing Method of Material Powder | | | Tumbling | Tumbling | Tumbling |
| | | | | Fluidized Bed | Fluidized Bed | Fluidized Bed |
| | | | | Granulation | Granulation | Granulation |
| | | | | Method | Method | Method |
| Forming | Forming Method | | | Calendar | Calendar | Calendar |
| Conditions | Long-Length | Release Sheet | | TP03 | TP03 | TP03 |
| | Sheet Forming | Number of rolling [times] | (Number of Rolled Member) | 4 | 4 | 1 |
| | Step | Corresponding FIG. | | FIG. 1 | FIG. 1 | FIG. 19 |
| | | First Rolled Member | Gap [mm] | 0.35 | 0.35 | 0.35 |
| | | Second Rolled Member | Gap [mm] | 0.30 | 0.30 | — |
| | | Third Rolled Member | Gap [mm] | 0.25 | 0.25 | — |
| | | Fourth Rolled Member | Gap [mm] | 0.20 | 0.20 | — |
| | | Fifth Rolled Member | Gap [mm] | — | — | — |
| | | Roll | Revolving Rate [m/min] | 0.5 | 0.5 | 0.5 |
| | | | Surface Temperature [° C.] | 80° C. | 90° C. | 80° C. |
| | Pressing Step | Release Sheet | Type | — | — | — |
| | | Release Sheet | Thickness [μm] | | | |
| | | Spacer | Thickness [mm] | | | |
| | | Number of Pressing | [times] | | | |
| | | Pressing Pressure | [MPa] | | | |
| | | Pressing Duration | [min] | | | |
| | | Pressing Temperature | [° C.] | | | |
| Properties of | Density | | g/cm³ | 1.759 | 1.759 | 1.452 |
| Thermally | Thickness | | μm | 263 | 263 | 754 |
| Conductive | Thermal | [W/m · K] | Plane Direction | 15.3 | 17.0 | 5.4 |
| Sheet | Conductivity | | Thickness Direction | 1.15 | 1.10 | 2.11 |

| | | | | |
|---|---|---|---|---|
| Flexibility | Bend Resistance | Good | Good | Poor |
| Porosity P | [vol %] | 10.1 | 10.1 | 25.8 |

TABLE 7

| | Complex Shear Viscosity η* (Pa · s) | | |
|---|---|---|---|
| | (Complex Viscosity) | | |
| Temperature [° C.] | Formulation 1 | Formulation 2 | Formulation 3 |
| 20 | 244800 | 27060 | 186800 |
| 30 | 196000 | 14320 | 39290 |
| 40 | 37770 | 10650 | 2205 |
| 50 | 10370 | 9090 | 298.7 |
| 60 | 6618 | 7970 | 136.5 |
| 70 | 5941 | 7142 | 118.6 |
| 80 | 5706 | 6516 | 131.1 |
| 90 | 5493 | 5748 | 116.7 |
| 100 | 5344 | 5003 | 247.7 |
| 110 | 5162 | 4211 | 210.3 |
| 120 | 4987 | 3443 | 1.936 |
| 130 | 4484 | 2898 | 0.5644 |
| 140 | 3909 | 2449 | 0.5531 |
| 150 | 3293 | 2008 | 1.238 |

TABLE B1

| | | | | Ex. B1 | Ex. B2 | Ex. B3 | Ex. B4 | Ex. B5 |
|---|---|---|---|---|---|---|---|---|
| Formulation | BN | PT-110 | | 1000 (70) | 1000 (70) | 1000 (70) | 1000 (70) | 15000 (70) |
| | Epoxy | EG-200 | | — | — | — | — | — |
| | Resin | EXA-1000 | | 22 | 22 | 22 | 22 | 327 |
| | | HP7200 | | 22 | 22 | 22 | 22 | 327 |
| | Curing | Phenol | MEH-7800-SS | 66 | 66 | 66 | 66 | 995 |
| | Agent | Compound | | | | | | |
| | | Imidazole | 2P4MHZ-PW | — | — | — | — | — |
| | | Compound | | | | | | |
| | Acrylic | SG-P3 (15 mass | | 762 | 762 | 762 | 762 | 11430 |
| | Resin | % MEK solution) | | | | | | |
| | Curing | 2MAOK-PW | | 436 | 436 | 436 | 436 | 65 |
| | Accelerator | | | | | | | |
| | Formulation | | | Formulation B1 | Formulation B1 | Formulation B1 | Formulation B1 | Formulation B1 |
| | Preparing Method Material Powder | | | Mixing and | Mixing and | Mixing and | Mixing and | Tumbling |
| | | | | Vacuum | Vacuum | Vacuum | Vacuum | Fluidized Bed |
| | | | | Drying | Drying | Drying | Drying | Granulation |
| | | | | Method | Method | Method | Method | Method |
| Forming | Forming Method | | | Calender + | Calender + | Calender + | Calender + | Calender + |
| Conditions | | | | Pressing | Pressing | Pressing | Pressing | Pressing |
| | Long- | Release Sheet | | TP03 | TP03 | TP03 | TP03 | TP03 |
| | Length | Number of Steps of | | 2 | 3 | 4 | 5 | 2 |
| | Sheet | Rolled Member | | | | | | |
| | Forming | Number of | Number of | 1 | 2 | 3 | 4 | 1 |
| | Step | Lamination | Steps of Sheet | | | | | |
| | | [Times] | Laminated | | | | | |
| | | | Portion | | | | | |
| | | Corresponding FIG. | | FIG. 6 | FIG. 1 | FIG. 1 | FIG. 1 | FIG. 6 |
| | | Rolled Member | Gap [mm] | 0.35 | 0.35 | 0.35 | 0.35 | 0.35 |
| | | Roll | Revolving Rate | 0.3 | 0.3 | 0.3 | 0.3 | 0.3 |
| | | | [m/min] | | | | | |
| | | | Surface | 70 | 70 | 70 | 70 | 70 |
| | | | Temperature | | | | | |
| | | | [° C.] | | | | | |
| | Pressing Step | Release Sheet | Type | SG2 | SG2 | SG2 | SG2 | SG2 |
| | | Release Sheet | Thickness [μm] | 50 | 50 | 50 | 50 | 50 |
| | | Spacer | Thickness [mm] | 0.2 | 0.2 | 0.2 | 0.2 | 0.2 |
| | | Number of | [times] | 1 | 1 | 1 | 1 | 1 |
| | | Pressing | | | | | | |
| | | Pressing | [MPa] | 60 | 60 | 60 | 60 | 60 |
| | | Pressure | | | | | | |
| | | Pressing | [min] | 10 | 10 | 10 | 10 | 10 |
| | | Duration | | | | | | |
| | | Pressing | [° C.] | 70 | 70 | 70 | 70 | 70 |
| | | Temperature | | | | | | |
| Properties | Density | | g/cm³ | 1.91 | 1.90 | 1.94 | 1.91 | 1.90 |
| of | Thickness | | μm | 200 | 217 | 181 | 172 | 260 |
| Thermally | Thermal | [W/m · K] | Plane Direction | 28.5 | 30.0 | 31.1 | 30.7 | 22.3 |
| Conductive | Conductivity | | Thickness | 1.50 | 1.35 | 1.21 | 1.42 | 1.62 |
| Sheet | | | Direction | | | | | |

| | | | | | | |
|---|---|---|---|---|---|---|
| Flexibility | Bend Resistance | Excellent | Excellent | Excellent | Excellent | Excellent |
| Porosity P | [vol %] | 2.3 | 2.9 | 1.1 | 2.6 | 2.7 |

TABLE B2

| | | | | Ex. B6 | Ex. B7 | Ex. B8 | Ex. B9 | Ex. B10 |
|---|---|---|---|---|---|---|---|---|
| Formulation | BN | PT-110 | | 15000 (70) | 600 (70) | 600 (70) | 600 (70) | 600 (70) |
| | Epoxy | EG-200 | | — | 44.24 | 44.24 | 44.24 | 44.24 |
| | Resin | EXA-1000 | | 327 | — | — | — | — |
| | | HP7200 | | 327 | — | — | — | — |
| | Curing | Phenol | MEH-7800-SS | 995 | 19.9 | 19.9 | 19.9 | 19.9 |
| | Agent | Compound | | | | | | |
| | | Imidazole | 2P4MHZ-PW | — | — | — | — | — |
| | | Compound | | | | | | |
| | Acrylic | SG-P3 (15 mass % MEK solution) | | 11430 | 457 | 457 | 457 | 457 |
| | Resin | | | | | | | |
| | Curing | 2MAOK-PW | | 65 | 4.424 | 4.424 | 4.424 | 4.424 |
| | Accelerator | | | | | | | |
| | Formulation | | | Formulation | Formulation | Formulation | Formulation | Formulation |
| | | | | B1 | B2 | B2 | B2 | B2 |
| | Preparing Method Material Powder | | | Tumbling | Tumbling | Tumbling | Tumbling | Tumbling |
| | | | | Fluidized | Fluidized | Fluidized | Fluidized | Fluidized |
| | | | | Bed | Bed | Bed | Bed | Bed |
| | | | | Granulation | Granulation | Granulation | Granulation | Granulation |
| | | | | Method | Method | Method | Method | Method |
| Forming | Forming Method | | | Calender + | Calender + | Calender + | Calender + | Calender + |
| Conditions | | | | Pressing | Pressing | Pressing | Pressing | Pressing |
| | Long- | Release Sheet | | TP03 | TP03 | TP03 | TP03 | TP03 |
| | Length | Number of Steps of Rolled Member | | 5 | 2 | 3 | 4 | 5 |
| | Sheet | Number of | Number of | 4 | 1 | 2 | 3 | 4 |
| | Forming | Lamination | Steps of Sheet | | | | | |
| | Step | [Times] | Laminated Portion | | | | | |
| | | Corresponding FIG. | | FIG. 1 | FIG. 6 | FIG. 1 | FIG. 1 | FIG. 1 |
| | | Rolled Member | Gap [mm] | 0.35 | 0.35 | 0.35 | 0.35 | 0.35 |
| | | Roll | Revolving | 0.3 | 0.3 | 0.3 | 0.3 | 0.3 |
| | | | Rate [m/min] | | | | | |
| | | | Surface | 70 | 70 | 70 | 70 | 70 |
| | | | Temperature | | | | | |
| | | | [° C.] | | | | | |
| | Pressing | Release Sheet | Type | SG2 | SG2 | SG2 | SG2 | SG2 |
| | Step | Release Sheet | Thickness [μm] | 50 | 50 | 50 | 50 | 50 |
| | | Spacer | Thickness [mm] | 0.2 | 0.2 | 0.2 | 0.2 | 0.2 |
| | | Number of | [times] | 1 | 1 | 1 | 1 | 1 |
| | | Pressing | | | | | | |
| | | Pressing | [MPa] | 60 | 60 | 60 | 60 | 60 |
| | | Pressure | | | | | | |
| | | Pressing Duration | [min] | 10 | 10 | 10 | 10 | 10 |
| | | Pressing Temperature | [° C.] | 70 | 70 | 70 | 70 | 70 |
| Properties | Density | | g/cm³ | 1.91 | 1.95 | 1.94 | 1.96 | 1.95 |
| of | Thickness | | μm | 271 | 219 | 234 | 213 | 259 |
| Thermally | Thermal | [W/m · K] | Plane Direction | 29.0 | 22.5 | 24.4 | 26.2 | 26.6 |
| Conductive | Conductivity | | Thickness Direction | 1.62 | 1.56 | 1.38 | 1.35 | 1.58 |

| | | | | | | | |
|---|---|---|---|---|---|---|---|
| Sheet | Flexibility | Bend Resistance | Excellent | Excellent | Excellent | Excellent | Excellent |
| | Porosity P | [vol %] | 2.5 | 0.1 | 0.7 | 0.0 | 0.2 |

TABLE B3

| | | | | Comp. | Comp. | Comp. | Comp. | Comp. |
|---|---|---|---|---|---|---|---|---|
| | | | | Ex. B1 | Ex. B2 | Ex. B3 | Ex. B4 | Ex. B5 |
| Formulation | BN | PT-110 | | 1000 (70) | 1000 (70) | 15000 (70) | 15000 (70) | 402.5 (70) |
| | Epoxy | EG-200 | | — | — | — | — | 90 |
| | Resin | EXA-1000 | | 22 | 22 | 327 | 327 | — |
| | | HP7200 | | 22 | 22 | 327 | 327 | — |
| | Curing | Phenol | MEH-7800-SS | 66 | 66 | 995 | 995 | — |
| | Agent | Compound | | | | | | |
| | | Imidazole | 2P4MHZ-PW | — | — | — | — | 0.9 |
| | | Compound | | | | | | |
| | Acrylic Resin | SG-P3 (15 mass % MEK solution) | | 762 | 762 | 11430 | 11430 | — |
| | Curing | 2MAOK-PW | | 4.36 | 4.36 | 65 | 65 | — |
| | Accelerator | | | | | | | |
| | Formulation | | | Formulation | Formulation | Formulation | Formulation | Formulation |
| | | | | B1 | B1 | B1 | B1 | B3 |
| | Preparing Method Material Powder | | | Mixing | Mixing | Tumbling | Tumbling | Mixing |
| | | | | and | and | Fluidized | Fluidized | and |
| | | | | Vacuum | Vacuum | Bed Granulation | Bed Granulation | Vacuum |
| | | | | Drying | Drying | Method | Method | Drying |
| | | | | Method | Method | | | Method |
| Forming | Forming Method | | | Pressing | Kneading + | Pressing | Kneading + | Pressing |
| Conditions | | | | | Pressing | | Pressing | |
| | Long- | Release Sheet | | — | (Kneading) | — | (Kneading) | — |
| | Length | Number of Steps of Rolled Member | | | | | | |
| | Sheet | Number of | Number of | | | | | |
| | Forming | Lamination | Steps of Sheet | | | | | |
| | Step | [Times] | Laminated Portion | | | | | |
| | | Corresponding FIG. | | | | | | |
| | | Rolled Member | Gap [mm] | | | | | |
| | | Roll | Revolving | | | | | |
| | | | Rate [m/min] | | | | | |
| | | | Surface | | | | | |
| | | | Temperature [° C.] | | | | | |
| | Pressing Step | Release Sheet | Type | MRF38 | MRF38 | MRF38 | MRF38 | MRF38 |
| | | Release Sheet | Thickness [μm] | 38 | 38 | 38 | 38 | 38 |
| | | Spacer | Thickness [mm] | Absence | Absence | Absence | Absence | Absence |
| | | Number of | [times] | 1 | 1 | 1 | 1 | 1 |
| | | Pressing | | | | | | |
| | | Pressing Pressure | [MPa] | 30 | 30 | 30 | 30 | 30 |
| | | Pressing Duration | [min] | 15 | 15 | 15 | 15 | 15 |
| | | Pressing | [° C.] | 80 | 80 | 80 | 80 | 80 |
| | | Temperature | | | | | | |
| Properties | Density | | g/cm³ | 1.89 | 1.89 | 1.83 | 1.89 | 1.82 |
| of | Thickness | | μm | 246 | 293 | 239 | 269 | 248 |
| Thermally | Thermal | [W/m · K] | Plane Direction | 21.2 | 25.9 | 16.0 | 19.1 | 16.2 |
| Conductive | Conductivity | | Thickness Direction | 249 | 1.54 | 3.01 | 2.33 | 3.23 |

| | | | | | | | |
|---|---|---|---|---|---|---|---|
| Sheet | Flexibility | Bend Resistance | Excellent | Poor | Excellent | Poor | Excellent |
| | Porosity P | [vol %] | 3.4 | 3.6 | 6.7 | 3.2 | 7.0 |

TABLE B4

| | | | | Comp. | Comp. | Comp. | Comp. | Comp. |
|---|---|---|---|---|---|---|---|---|
| | | | | Ex. B6 | Ex. B7 | Ex. B8 | Ex. B9 | Ex. B10 |
| Formulation | BN | PT-110 | | 402.5 (70) | 402.5 (70) | 1000 (70) | 1000 (70) | 1000 (70) |
| | Epoxy | EG-200 | | 90 | 90 | — | — | — |
| | Resin | EXA-1000 | | — | — | 22 | 22 | 22 |
| | | HP7200 | | — | — | 22 | 22 | 22 |
| | Curing | Phenol Compound | MEH-7800-SS | — | — | 66 | 66 | 66 |
| | Agent | Imidazole | 2P4MHZ-PW | 0.9 | 0.9 | — | — | — |
| | | Compound | | | | | | |
| | Acrylic | SG-P3 (15 mass % MEK solution) | | — | — | 762 | 762 | 762 |
| | Resin | | | | | | | |
| | Curing | 2MAOK-PW | | — | — | 4.36 | 4.36 | 4.36 |
| | Accelerator | | | | | | | |
| | Formulation | | | Formulation | Formulation | Formulation | Formulation | Formulation |
| | | | | B3 | B3 | B1 | B1 | B1 |
| | Preparing Method Material Powder | | | Mixing and | Mixing and | Mixing and | Mixing and | Mixing and |
| | | | | Vacuum | Vacuum | Vacuum | Vacuum | Vacuum |
| | | | | Drying | Drying | Drying | Drying | Drying |
| | | | | Method | Method | Method | Method | Method |
| Forming | Forming Method | | | Kneading and | Kneading and | Calender | Calender | Calender |
| Conditions | | | | Extruding*1 | Extruding*1 + | | | |
| | | | | | Pressing | | | |
| | Long- | Release Sheet | | (Kneading | (Kneading | TP03 | TP03 | TP03 |
| | Length | Number of Steps of Rolled Member | | and | and | 1 | 2 | 3 |
| | Sheet | Number of | Number of | Extruding*1) | Extruding*1) | 0 | 1 | 2 |
| | Forming | Lamination | Steps of Sheet | | | | | |
| | Step | [Times] | Laminated Portion | | | | | |
| | | Corresponding FIG. | | | | FIG. 9 | FIG. 1 | FIG. 1 |
| | | Rolled Member | Gap [mm] | | | 0.35 | 0.35 | 0.35 |
| | | Roll | Revolving Rate | | | 0.3 | 0.3 | 0.3 |
| | | | [m/min] | | | | | |
| | | | Surface | | | 70 | 70 | 70 |
| | | | Temperature [° C.] | | | | | |
| | Pressing | Release Sheet | Type | — | SG2 | — | — | — |
| | Step | Release Sheet | Thickness [μm] | — | 50 | | | |
| | | Spacer | Thickness [mm] | — | 0.2 | | | |
| | | Number of Pressing | [times] | — | 1 | | | |
| | | Pressing Pressure | [MPa] | — | 60 | | | |
| | | Pressing Duration | [min] | — | 10 | | | |
| | | Pressing | [° C.] | — | 70 | | | |
| | | Temperature | | | | | | |
| Properties | Density | | g/cm³ | 1.75 | 1.81 | 1.78 | 1.80 | 1.71 |
| of | Thickness | | μm | 1591 | 273 | 175 | 144 | 257 |
| Thermally | Thermal | [W/m · K] | Plane Direction | 6.0 | 18.6 | 17.1 | 17.2 | 13.8 |
| Conductive | Conductivity | | Thickness | 274 | 1.83 | 1.08 | 0.99 | 0.58 |
| Sheet | | | Direction | | | | | |

| | | | | | | |
|---|---|---|---|---|---|---|
| Flexibility | Bend Resistance | Bad | Excellent | Excellent | Excellent | Excellent |
| Porosity P | [vol %] | 10.6 | 7.6 | 8.9 | 8.1 | 12.8 |

*1Extruding Conditions: Extruding rate of 0.4 m/min, Extruding Temperature of 60 to 80° C.

TABLE B5

| | | | | Comp. | Comp. | Comp. | Comp. | Comp. |
|---|---|---|---|---|---|---|---|---|
| | | | | Ex. B11 | Ex. B12 | Ex. B13 | Ex. B14 | Ex. B15 |
| Formulation | BN | PT-110 | | 1000 (70) | 1000 (70) | 600 (70) | 15000 (70) | 600 (70) |
| | Epoxy | EG-200 | | — | — | — | — | — |
| | Resin | EXA-1000 | | 22 | 22 | 13 | 327 | 13 |
| | | HP7200 | | 22 | 22 | 13 | 327 | 13 |
| | Curing | Phenol | MEH-7800-SS | 66 | 66 | 40 | 995 | 40 |
| | Agent | Compound | | | | | | |
| | | Imidazole | 2P4MHZ-PW | — | — | — | — | — |
| | | Compound | | | | | | |
| | Acrylic Resin | SG-P3 (15 mass % MEK solution) | | 762 | 762 | 457 | 11430 | 457 |
| | Curing | 2MAOK-PW | | 4.36 | 4.36 | 2.62 | 65 | 2.62 |
| | Accelerator | | | | | | | |
| | Formulation | | | Formulation | Formulation | Formulation | Formulation | Formulation |
| | | | | B1 | B1 | B1 | B1 | B1 |
| | Preparing Method Material Powder | | | Mixing and | Mixing and | Tumbling | Tumbling | Tumbling |
| | | | | Vacuum | Vacuum | Fluidized | Fluidized | Fluidized |
| | | | | Drying | Drying | Bed | Bed | Bed |
| | | | | Method | Method | Granulation | Granulation | Granulation |
| | | | | | | Method | Method | Method |
| Forming | Forming Method | | | Calender | Calender | Calender | Calender | Calender |
| Conditions | Long- | Release Sheet | | TP03 | TP03 | TP03 | TP03 | TP03 |
| | Length | Number of Steps of Rolled Member | | 4 | 5 | 1 | 3 | 5 |
| | Sheet | Number of | Number of | 3 | 4 | 0 | 2 | 4 |
| | Forming | Lamination | Steps of Sheet | | | | | |
| | Step | [Times] | Laminated Portion | | | | | |
| | | Corresponding FIG. | | FIG. 1 | FIG. 1 | FIG. 9 | FIG. 1 | FIG. 1 |
| | | Rolled Member | Gap [mm] | 0.35 | 0.35 | 0.35 | 0.35 | 0.35 |
| | | Roll | Revolving | 0.3 | 0.3 | 0.3 | 0.3 | 0.3 |
| | | | Rate [m/min] | | | | | |
| | | | Surface | 70 | 70 | 70 | 70 | 70 |
| | | | Temperature [° C.] | | | | | |
| | Pressing | Release Sheet | Type | — | — | — | — | — |
| | Step | Release Sheet | Thickness [μm] | | | | | |
| | | Spacer | Thickness [mm] | | | | | |
| | | Number of | [times] | | | | | |
| | | Pressing | | | | | | |
| | | Pressing Pressure | [MPa] | | | | | |
| | | Pressing Duration | [min] | | | | | |
| | | Pressing | [° C.] | | | | | |
| | | Temperature | | | | | | |
| Properties | Density | | g/cm³ | 1.75 | 1.77 | 1.75 | 1.75 | 1.77 |
| of | Thickness | | μm | 241 | 232 | 276 | 270 | 261 |
| Thermally | Thermal | [W/m · K] | Plane Direction | 15.8 | 18.1 | 12.1 | 22.7 | 16.7 |
| Conductive | Conductivity | | Thickness | 0.88 | 0.91 | 0.93 | 1.18 | 0.88 |
| Sheet | | | Direction | | | | | |

| | | | | | | |
|---|---|---|---|---|---|---|
| Flexibility | Bend Resistance | Excellent | Excellent | Excellent | Excellent | Excellent |
| Porosity P | [vol %] | 10.5 | 9.7 | 10.5 | 10.6 | 9.4 |

TABLE B6

| | | | | Comp. | Comp. | Comp. | Comp. | Comp. | Comp. |
|---|---|---|---|---|---|---|---|---|---|
| | | | | Ex. B16 | Ex. B17 | Ex. B18 | Ex. B19 | Ex. B20 | Ex. B21 |
| Formulation | BN | PT-110 | | 600 (70) | 600 (70) | 600 (70) | 600 (70) | 600 (70) | 15000 (70) |
| | Epoxy Resin | EG-200 | | 44.24 | 44.24 | 44.24 | 44.24 | 44.24 | — |
| | | EXA-1000 | | — | — | — | — | — | 327 |
| | | HP7200 | | — | — | — | — | — | 327 |
| | Curing | Phenol | MEH-7800-SS | 19.9 | 19.9 | 19.9 | 19.9 | 19.9 | 99.5 |
| | Agent | Compound | | | | | | | |
| | | Imidazole | 2P4MHZ-PW | — | — | — | — | — | — |
| | | Compound | | | | | | | |
| | Acrylic | SG-P3 (15 mass % MEK solution) | | 457 | 457 | 457 | 457 | 457 | 11430 |
| | Resin | | | | | | | | |
| | Curing | 2MAOK-PW | | 4.424 | 4.424 | 4.424 | 4.424 | 4.424 | 65 |
| | Accelerator | | | | | | | | |
| | Formulation | | | Formu- | Formu- | Formu- | Formu- | Formu- | Formu- |
| | | | | lation | lation | lation | lation | lation | lation |
| | | | | B2 | B2 | B2 | B2 | B2 | B1 |
| | Preparing Method Material Powder | | | Tumbling | Tumbling | Tumbling | Tumbling | Tumbling | Tumbling |
| | | | | Fluidized | Fluidized | Fluidized | Fluidized | Fluidized | Fluidized |
| | | | | Bed | Bed | Bed | Bed | Bed | Bed |
| | | | | Granulation | Granulation | Granulation | Granulation | Granulation | Granulation |
| | | | | Method | Method | Method | Method | Method | Method |
| Forming | Forming Method | | | Calender | Calender | Calender | Calender | Calender | Calender |
| Conditions | Long- | Release Sheet | | TP03 | TP03 | TP03 | TP03 | TP03 | TP03 |
| | Length | Number of Steps of Rolled Member | | 1 | 2 | 3 | 4 | 5 | 1 |
| | Sheet | Number of | Number of | 0 | 1 | 2 | 3 | 4 | 0 |
| | Forming | Lamination | Steps of Sheet | | | | | | |
| | Step | [Times] | Laminated | | | | | | |
| | | | Portion | | | | | | |
| | | Corresponding FIG. | | FIG. 9 | FIG. 1 | FIG. 1 | FIG. 1 | FIG. 1 | FIG. 9 |
| | | Rolled Member | Gap [mm] | 0.35 | 0.35 | 0.35 | 0.35 | 0.35 | 0.35 |
| | | Roll | Revolving Rate | 0.3 | 0.3 | 0.3 | 0.3 | 0.3 | 0.5 |
| | | | [m/min] | | | | | | |
| | | | Surface | 70 | 70 | 70 | 70 | 70 | 80 |
| | | | Temperature | | | | | | |
| | | | [° C.] | | | | | | |
| | Pressing | Release Sheet | Type | — | — | — | — | — | — |
| | Step | Release Sheet | Thickness [μm] | | | | | | |
| | | Spacer | Thickness [mm] | | | | | | |
| | | Number of | [times] | | | | | | |
| | | Pressing | | | | | | | |
| | | Pressing Pressure | [MPa] | | | | | | |
| | | Pressing Duration | [min] | | | | | | |
| | | Pressing | [° C.] | | | | | | |
| | | Temperature | | | | | | | |
| Properties | Density | | g/cm³ | 1.76 | 1.83 | 1.80 | 1.81 | 1.82 | 1.45 |
| of | Thickness | | μm | 188 | 208 | 220 | 224 | 219 | 754 |
| Thermally | Thermal | [W/m · K] | Plane Direction | 12.4 | 15.9 | 16.2 | 18.0 | 18.6 | 5.4 |
| Conductive | Conductivity | | Thickness | 0.94 | 1.04 | 0.87 | 1.03 | 1.01 | 2.11 |
| Sheet | | | Direction | | | | | | |

| | | | | | | | |
|---|---|---|---|---|---|---|---|
| Flexibility | Bend Resistance | Excellent | Excellent | Excellent | Excellent | Excellent | Poor |
| Porosity P | [vol %] | 10.2 | 6.3 | 8.1 | 7.4 | 7.2 | 25.8 |

TABLE B7

| | Complex Shear Viscosity η* (Pa · s) | | |
|---|---|---|---|
| | (Complex Viscosity) | | |
| Temperature [° C.] | Formulation B1 | Formulation B2 | Formulation B3 |
| 20 | 244800 | 27060 | 186800 |
| 30 | 196000 | 14320 | 39290 |
| 40 | 37770 | 10650 | 2205 |
| 50 | 10370 | 9090 | 298.7 |
| 60 | 6618 | 7970 | 136.5 |
| 70 | 5941 | 7142 | 118.6 |
| 80 | 5706 | 6516 | 131.1 |
| 90 | 5493 | 5748 | 116.7 |
| 100 | 5344 | 5003 | 247.7 |
| 110 | 5162 | 4211 | 210.3 |
| 120 | 4987 | 3443 | 1.936 |
| 130 | 4484 | 2898 | 0.5644 |
| 140 | 3909 | 2449 | 0.5531 |
| 150 | 3293 | 2008 | 1.238 |

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### INDUSTRIAL APPLICABILITY

The thermally conductive sheet of the present invention is, for example, used by covering an electronic element such as an IC (integrated circuit) chip, a condenser, a coil, a resistor, and a light emitting diode.

1. A method for producing a thermally conductive sheet comprising the steps of:
preparing a material component containing boron nitride particles in a plate shape and a polymer matrix,
forming a long-length sheet from the material component with a calender, and
pressing the long-length sheet.

2. The method for producing a thermally conductive sheet according to claim 1, wherein
the calender is provided with a plurality of rolls that are disposed so that a plurality of nip portions are formed therein and
a gap of a downstream-side nip portion is smaller than that of an upstream-side nip portion in the upstream-side nip portion and the downstream-side nip portion that are adjacent to each other in a conveying direction of the long-length sheet.

3. The method for producing a thermally conductive sheet according to claim 2, wherein
in the two nip portions of the upstream-side nip portion and the downstream-side nip portion, a gap of the downstream-side nip portion with respect to a gap of the upstream-side nip portion is 0.9 times or less.

4. The method for producing a thermally conductive sheet according to claim 1, wherein
at least three nip portions are provided in the calender.

5. The method for producing a thermally conductive sheet according to claim 1, wherein
the calender is provided with a plurality of pairs of rolls that are disposed in opposed relation to each other along the conveying direction.

6. The method for producing a thermally conductive sheet according to claim 1, wherein
the thermally conductive sheet has a porosity of 3.0 vol % or less.

7. The method for producing a thermally conductive sheet according to claim 1, wherein
the thermally conductive sheet has a complex shear viscosity η* of 300 Pa·s or more and 10000 Pa·s or less at a temperature of 20 to 150° C. obtained by a dynamic viscoelasticity measurement in conformity with JIS K7244-10 (in 2005) at a frequency of 10 Hz and a temperature rising rate of 2° C./min.

8. The method for producing a thermally conductive sheet according to claim 1, wherein
the boron nitride particles measured by a dynamic light scattering method have an average particle size of 20 μm or more and
the volume ratio of the boron nitride particles in the thermally conductive sheet is 60 vol % or more.

9. The method for producing a thermally conductive sheet according to claim 1, wherein
the thermal conductivity in a direction perpendicular to a thickness direction of the thermally conductive sheet is 6 W/m·K or more.

10. The method for producing a thermally conductive sheet according to claim 1, wherein
the step of forming the long-length sheet includes the steps of:
forming the long-length sheet by extending the material component by applying pressure with the one pair of rolls and
laminating a plurality of the long-length sheets in the thickness direction to be extended by applying pressure with the one pair of rolls.
